(19) United States
(12) Patent Application Publication
(10) Pub. No.: US 2021/0349955 A1
(43) Pub. Date: Nov. 11, 2021

(54) SYSTEMS AND METHODS FOR REAL ESTATE DATA COLLECTION, NORMALIZATION, AND VISUALIZATION

(71) Applicant: Phillips Edison Grocery Center Operating Partnership I, L.P., Cincinnati, OH (US)

(72) Inventors: Cherilyn MEGILL, Kaysville, UT (US); Dawn STAMPER, Cincinnati, OH (US); Jeffrey S. EDISON, Salt Lake City, UT (US); Chris P. RICHARD, Cincinnati, OH (US); Katelyn A. WLOSZEK, Cincinnati, OH (US); Eric N. RICHTER, Cincinnati, OH (US); ASHLEY L. JANSZEN, West Harrison, IN (US)

(73) Assignee: Phillips Edison Grocery Center Operating Partnership I, L.P., Cincinnati, OH (US)

(21) Appl. No.: 17/302,710

(22) Filed: May 11, 2021

Related U.S. Application Data
(60) Provisional application No. 63/023,159, filed on May 11, 2020.

(51) Int. Cl. G06F 16/955; G06F 16/16; G06F 16/2457; G06F 21/62

(52) U.S. Cl. CPC G06F 16/955; G06F 21/62; G06F 16/2457; G06F 16/168

(57) ABSTRACT

A system for generating personalized uniform resource locators for data collection. The system may include a processor and a memory device storing instructions that configure processor to perform operations. The operations may include configuring an application programming interface (API) to communicate with a repository server storing information from real estate properties, retrieving (using the API) records of real estate properties and identifying a subset of users with upcoming reporting duties. The operations may also include generating personalized URLs encoding client identifiers (IDs) and account IDs for users in the subset, transmitting the personalized URLs to client devices, and receiving a website request through one of the personalized URLs. The operations may also include determining a client ID and an account ID embedded a personalized URL; and generating a data collection website comprising a collection graphical user interface (GUI).

### CROSS-REFERENCE TO RELATED APPLICATIONS

This application claims the benefit of priority under 35 U.S.C. 119(e) to U.S. provisional application No. 63/023,159, filed May 11, 2020. The disclosure of the above-referenced application is expressly incorporated herein by reference in its entirety.

### TECHNICAL FIELD

The present disclosure relates generally to systems and methods for processing real estate data and, more particularly, to systems and methods that provide data collection, normalization, and visualizations by collecting real estate information from multiple sources with the use of personalized uniform resource locators (URLs), standardize it using machine-learning classification models, and create data models for visualization and search.

### BACKGROUND

Digitization of information has enabled automation, simplified process flows, and large scale data collection in many industries. Digital information has allowed the creation of multiple tools and applications that improved management and enhanced services in many industries. For example, the digitization of information resulted in new applications that facilitate process flows in finance, medicine, and education.

Recently, however, the digitization of information has created new technical challenges. For example, it is becoming increasingly difficult to collect, aggregate, store, and analyze the very large sets of digital data. Large amounts of digital data are generated and recorded very quickly making it difficult to generate insights in a timely manner and to efficiently store information. Moreover, it is becoming progressively more difficult to secure and validate digital data. For example, when digital data is retrieved from multiple sources it is necessary to validate data quickly to prevent inconsistencies. But this quick validation has technological challenges. Thus, the variety of digital data sources has led to important and complex challenges in data integration. Digital data comes from disparate sources, like enterprise applications, users, and/or documents. Collecting data, combining the data, and reconciling it, so that it can be used to create reports, can be difficult. Further, organizations employing digital data need to address security concerns because digitization of data creates risks of hacking and/or advanced persistent threats (APIs).

Data integration has been particularly challenging for applications using real estate digital data. Because of peculiarities in real estate, such as the variety of data sources, a need for user input, and the level of digitization, it has been challenging to meaningfully integrate data. Frequently, real estate data cannot be analyzed with conventional analytical methods because they do not have the capabilities to consider different sources and/or different formats from the variety of parties. Thus, analysts of real estate data may be required to manually consider records to identify actions and/or discern patterns. Further, integration of real estate digital data has been difficult because each real estate operation deals with many systems that are frequently uncommunicated and operate under different parameters. For example, an apartment building may require a system for utilities, a system for users, a system for accounting, a system for maintenance, a system for marketing, etc. In many scenarios, these different systems work independently and without central coordination. At the same time, some of the information that is relevant for real estate applications is difficult to categorize to, for example, determine levels of accessibility by different users.

The lack of integration for real estate digital data has resulted in poor accessibility and/or complex system schemes that are inefficient, cumbersome, or expensive. For example, certain users need to access multiple systems in order to perform even basic real estate operations. Additionally, the lack of effective integration of real estate data prevents coordinated and/or centralized management.

The disclosed computer-implemented systems and identification methods address one or more of the problems set forth above and/or other problems in the prior art.

### SUMMARY

One aspect of the present disclosure is directed to systems and methods for real estate data normalization that may include data aggregators and normalizers working in conjunction to collect and analyze information. In such embodiments, the disclosed systems and methods may employ one or more application programming interfaces (APIs) to interact with multiple systems. Further, such embodiments may also use techniques for automated data collection and digitization. The disclosed systems and methods may also apply machine-learning techniques trained to categorize real estate data and/or automate API configuration. Accordingly, some of the disclosed systems and methods may improve the technical field of data integration for real estate, leveraging techniques that facilitate integration of complex and diverse data.

Other aspects of the present disclosure are directed to systems and methods for data visualizations. In particular, some of the disclosed systems and methods are directed to service platforms that allow access and display data of integrated real estate data. In some embodiments, the disclosed systems and methods may provide consolidated, searchable repositories of information. In addition, the disclosed systems and methods may provide communication portals for real estate operations. In such embodiments the disclosed systems and methods may provide communication platforms that use integrated digital real estate data to, for example, allow tenants to communicate, track, and record activity and/or information.

Yet other aspects of the disclosed systems and methods may be directed to methods for the generation of graphical user interfaces (GUIs) that facilitate data visualization of normalized and integrated real estate data. In such embodiments, the disclosed systems and methods may use integrated real estate data to generate GUIs that centralize requests, display information, and enable searching tasks. Further, some of these embodiments may also be directed to displaying GUIs showing real estate data in mobile devices or wearable devices.

Other aspects of this disclosure are directed to systems that may categorize real estate data and associate it with customized data models that facilitate communication, search, and analysis. The disclosed systems and methods may employ data classification and correlation techniques that enable computer-implemented methods for faster visualization and accessing of multiple technologies. For example, the disclosed systems and methods may apply normalization techniques to automatically normalize multi-sourced data and store them in customized data structures. Further, in such embodiments the disclosed systems and methods may provide comprehensive analytics tools to track activity in online tools.

Other aspects of this disclosure are directed to managing access to integrated real estate data using different authentication protocols. For example, the disclosed systems and methods may provide means for determining level of access to integrated real estate data. In such embodiments, the disclosed systems and methods may perform authentication functions to identify roles for different users or entities and provide rights. Based on the identified role, the disclosed systems and methods may also configure communication channels. For example, in certain embodiments, the disclosed systems and methods may create encrypted channels between different users and/or client devices to securely transmit information or data analytics.

Other aspect of the present disclosure is directed to a system for generating personalized uniform resource locators (URLs) for data collection. The system may include at least one processor and at least one memory device storing instructions that, when executed by the at least one processor, configure the at least one processor to perform operations. The operations may include configuring an application programming interface (API) to communicate with a repository server storing information from real estate properties, retrieving, using the API, records of real estate properties associated with a plurality of users, and identifying a subset of the plurality of users with upcoming reporting duties, based on the records. The operations may also include generating personalized URLs encoding client identifiers (IDs) and account IDs for users in the subset, transmitting the personalized URLs to client devices, and receiving, from one of the client devices, a website request through one of the personalized URLs. The operations may also include, in response to receiving the website request, determining a client ID and an account ID embedded in the one of the personalized URL through which the website request was received; and generating a data collection website comprising a collection graphical user interface (GUI) displaying the client ID, a reporting period, and an input element.

Yet another aspect of the present disclosure is directed to a computer-implemented method for generating personalized uniform resource locators for data collection. The method may include configuring an application programming interface (API) to communicate with a repository server storing information from real estate properties, retrieving (using the API) records of real estate properties associated with a plurality of users, and identifying a subset of the plurality of users with upcoming reporting duties, based on the records. The method may also include generating personalized URLs encoding client identifiers (IDs) and account IDs for users in the subset, transmitting the personalized URLs to client devices, and receiving, from one of the client devices, a website request through one of the personalized URLs. The method may also include, in response to receiving the website request, determining a client ID and an account ID embedded in the one of the personalized URL through which the website request was received; and generating a data collection website comprising a collection graphical user interface (GUI) displaying the client ID, a reporting period, and an input element.

Another aspect of the present disclosure is directed to a system. The system may include one or more processors, one or more database storing information from real estate properties, and at least one memory device storing instructions that, when executed by the at least one processor, configure the at least one processor to: configure an application programming interface (API) to communicate with a repository server storing information from real estate properties, retrieve (using the API) records of real estate properties associated with a plurality of users, and identify a subset of the plurality of users with upcoming reporting duties, based on the records. The instructions may also configure the processor to generate personalized URLs encoding client identifiers (IDs) and account IDs for users in the subset, transmit the personalized URLs to client devices, receive a website request through one of the personalized URLs. Further, the instructions may also configure the processor to, in response to receiving the website request, determine a client ID and an account ID embedded in the one of the personalized URL through which the website request was received; and generate a data collection website comprising a collection graphical user interface (GUI) displaying the client ID, a reporting period, and an input element.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 is a block diagram of an exemplary system, in accordance with disclosed embodiments.

FIG. 2 is a block diagram of an exemplary document normalizer and aggregator, in accordance with disclosed embodiments.

FIG. 3 is a block diagram of an exemplary API configurator, in accordance with disclosed embodiments.

FIG. 4 is a block diagram of an exemplary database, in accordance with disclosed embodiments.

FIG. 5 is a block diagram of an exemplary client device, in accordance with disclosed embodiments.

FIG. 6 is a flow chart illustrating an exemplary data integration process, in accordance with disclosed embodiments.

FIG. 7 is a flow chart illustrating an exemplary access granting process, in accordance with disclosed embodiments.

FIG. 8 is a flow chart illustrating an exemplary document analysis process, in accordance with disclosed embodiments.

FIG. 9 is a flow chart illustrating an exemplary process for generating a classification model, in accordance with disclosed embodiments

FIG. 10 shows an exemplary first graphical user interface for accessing integrated data, in accordance with disclosed embodiments.

FIG. 11 shows an exemplary second graphical user interface for displaying requests, in accordance with disclosed embodiments.

FIG. 12 shows an exemplary third graphical user interface for displaying notifications, in accordance with disclosed embodiments.

FIG. 13 shows an exemplary fourth graphical user interface for displaying a property directory, in accordance with disclosed embodiments.

FIG. 14 shows an exemplary fifth graphical user interface for displaying real estate data visualization, in accordance with disclosed embodiments.

FIG. 15 shows an exemplary sixth graphical user interface for displaying and collecting property information, in accordance with disclosed embodiments.

FIG. 16 shows an exemplary seventh graphical user interface for accessing integrated data via mobile devices, in accordance with disclosed embodiments.

FIG. 17 shows an exemplary graphical representation of a property data model, in accordance with disclosed embodiments.

FIG. 18 shows an exemplary graphical representation of a ledger data model, in accordance with disclosed embodiments.

FIG. 19 shows an exemplary graphical representation of a document data model, in accordance with disclosed embodiments.

FIG. 20 shows an exemplary graphical representation of a help desk data model, in accordance with disclosed embodiments.

FIG. 21 shows an exemplary graphical representation of a communications data model, in accordance with disclosed embodiments.

FIG. 22 is an exemplary flow chart illustrating a process for generating personalized uniform resource locators, in accordance with disclosed embodiments.

FIG. 23 is an exemplary flow chart illustrating a process for authenticating users and displaying graphical user interfaces, in accordance with disclosed embodiments.

FIG. 24 is an exemplary flow chart illustrating a process for collection of user data, in accordance with disclosed embodiments.

FIG. 25 shows an exemplary graphical user interface displaying a periodic record, in accordance with disclosed embodiments.

FIGS. 26A and 26B show exemplary graphical user interfaces for collection of user data, in accordance with disclosed embodiments.

FIG. 27 shows an exemplary loader graphical user interface for administrator users, in accordance with disclosed embodiments.

FIG. 28 shows an exemplary approval graphical user interface, in accordance with disclosed embodiments.

FIG. 29 shows an exemplary graphical user interface with an electronic notification for users, in accordance with disclosed embodiments.

### DETAILED DESCRIPTION

The disclosure is generally directed to computer implemented methods for integration, analysis, and visualization of real estate data. The disclosed methods may improve the technical field of data analytics with tools that allow users to integrate multi-sourced and multi-formatted real estate data to generate centralized repositories. Further, the disclosed methods may create searchable data structures tailored for different data type categories, which may be stored in the centralized repository. In such configurations, the disclosed systems and methods may facilitate data analytics and visualization using machine-learning techniques to categorize information and generate tailored data structures or data models. Moreover, some embodiments of the disclosed systems and methods may enable automated generation of GUIs. In such embodiments, the disclosed systems and methods may use integrated real estate data to generate GUIs that display integrated real estate data.

Moreover, the disclosed systems and methods may employ the integrated real estate data to generate websites and/or web resources for real estate service platforms. In such embodiments, the real estate service platforms may provide a consolidated, searchable repository of information and a communication portal for tenants and owners. The service platform may support multiple operations related to real estate management. For example, the service platforms may support tenant ledger features, document and data management features, and help desk features. Further, the generated service platform may also include communications features, alert and reporting systems, and user role determination features.

Alternatively, or additionally, disclosed systems and methods may improve real estate management tools by resolving formatting differences and allowing system integration using APIs that communicate disparate systems. Disclosed systems and methods may create a network-based real estate management method that collects, converts and consolidates real estate data from various sources into standardized formats and/or categorized data structures. Some disclosed systems and methods may also store the generated formats or data structures in network-based storage devices, and generate messages notifying users that information is updated or requests have been issued. The disclosed method may also provide GUIs by a content server, which may include hardware or a combination of both hardware and software. A user, such as tenant of real estate property may be given remote access to the integrated data through the GUI to view or update information about a property using the user's own local device (e.g., a personal computer or wireless handheld device). When a user wants to update the records, the user can input the update in any format used by the user's local device. Whenever the real estate information is updated (either by a user or an associated system communicating through an API), the disclosed system may perform operations to integrate the data in the centralized repository. The disclosed systems may convert user data into the standardized format, generate a searchable data structure, and store it the centralized repository. The updated information may be, for example, stored in a content server, which is connected to the network-based storage devices.

Moreover, the disclosed methods may be configurable to facilitate communication with different parties associated with real estate operations. In such embodiments, the disclosed methods and systems may automatically generate messages containing updated information about real estate. The messages may be transmitted in a standardized format over the computer network to users, or to selected users based on their determined role. In such embodiments, the disclosed systems and methods may include broadcasting options so that users can quickly be notified of any changes without having to manually look up or consolidate the providers' updates. Nonetheless, in some embodiments, the disclosed systems and methods may include mechanisms for encryption of information. Based on associated data structures and levels of access for selected users, the disclosed systems and methods may perform encryption operations that ensures each group of users may be given immediate notice and access to changes, so they can readily adapt work schedules. Moreover, in such embodiments the communication techniques may be specific for each type of data structure. For instance, data structures associated with recurrent real estate information (such as monthly payments) may be encrypted with different tools than non-recurrent real estate information (such as maintenance requests).

Moreover, to facilitate communication with users, the disclosed systems and methods may leverage aggregated information to program, train, and/or enable Chatbots that interact with users of the system. Chatbots are software-implemented conversation tools that automatically communicate with users via auditory or textual methods. Some of the disclosed systems and methods may use Chatbots that use aggregated real estate data, in addition to analysis of historic records, to simulate human interactions in response to client queues. For example, the disclosed systems and methods may implement dialog system Chatbots that use natural language processing systems to reply to messages from users. In these embodiments, the disclosed systems and methods may perform Chatbot applications tailored for real estate operations and for customer interactions. For instance, the disclosed systems and methods may use existing conversation data between tenants and property owners to understand the type of questions people ask, analyze correct answers to those questions through a ‘training’ period, and use machine learning to learn context and improve future answers.

Furthermore, the disclosed systems and methods may include a combination of networking elements that allow efficient storing of information using specialized data structures or models. For example, disclosed systems may provide remote access over a network, convert updated information that was input by a user in a non-standardized form to a standardized format, automatically generate messages or GUIs whenever updated information is stored, automatically transmit the message to all or selected users (selected based on rolls), and automatically place requests associated with real estate property based on analysis of integrated information. Thus, the disclosed combination of elements may improve management systems by allowing remote users to share information in real time in a standardized format regardless of the format in which the information was input by the user. Further, the disclosed systems and methods may configure APIs to facilitate interaction between different systems. For example, a real estate system may couple properties with vendors or maintenance services. In such scenarios, the disclosed systems and methods may use integrated information to automatically configure APIs and directly place requests in systems of vendors or service providers.

Moreover, the disclosed systems and methods may improve operability of web resources by allowing integration of multiple services within a single website. For example, disclosed systems and methods may allow users to access a single modified website that integrates multiple applications of the real estate operation. In such embodiments, internet hyperlink protocols may be configured to dynamically produce a multi-source hybrid webpages that display both real estate functions and marketing functions.

Moreover, the disclosed systems and methods may improve the field of data aggregation by employing personalized or customized URLs that encode identifications or cookies. For example, disclosed systems and methods may resolve problems of collection of data from users in a network. Collecting information from users can be cumbersome in multiple platforms. Users may input data in different formats and/or at different times. Further, users may neglect to report information or enter incorrect information that is not usable for aggregation. The disclosed systems and methods improve the technical field of data collection, normalization, and analysis, by generating personalized URLs that allow simple, uniform, and efficient collection of user data. The use of personalized URLs may also improve the technical field of data collection in a distributed network. In particular, the disclosed processes may reduce network congestion in servers of integration systems by directly taking users to specific landing pages. Thus, disclosed embodiments may improve congestions distributed in network architecture.

Furthermore, some embodiments of the disclosed systems and methods may address problems of data visualization in computer and or mobile devices displays by selecting the information that is presented to users and the position and size of icons that are shown. For example, some embodiments of the disclosed methods may generate GUIs in which icons get automatically organized on the GUI based on most used icons and/or more urgent tasks. For example, the disclosed systems and methods may provide means for rearranging icons on a GUI based on requirements of the integrated real estate data. In such embodiments, the disclosed system may rank icons and/or information associated with a property based on use or importance. For instance, a processor in the disclosed systems may track the number of times each icon is selected or how much memory has been allocated to the individual processes associated with each icon over a period of time (e.g., day, week, month. etc.). Alternatively, or additionally, the disclosed systems and methods may rank icons based on a level of urgency that results from data analytics processes. Based on the level of urgency or use, the disclosed systems and methods may create tailored GUIs for each user that take into account, their role, pending tasks, and available screen space. In such embodiments, the disclosed systems and methods may also create tailored GUIs to collect information. For example, the disclosed systems may generate GUIs that guide users through document uploading and/or downloading processes that facilitate later data normalization and/or standardization. Such specifically generated GUIs may improve the accuracy of user interactions by displaying selected information and automating certain entries to prevent inaccurate entries.

Reference will now be made in detail to the disclosed embodiments, examples of which are illustrated in the accompanying drawings.

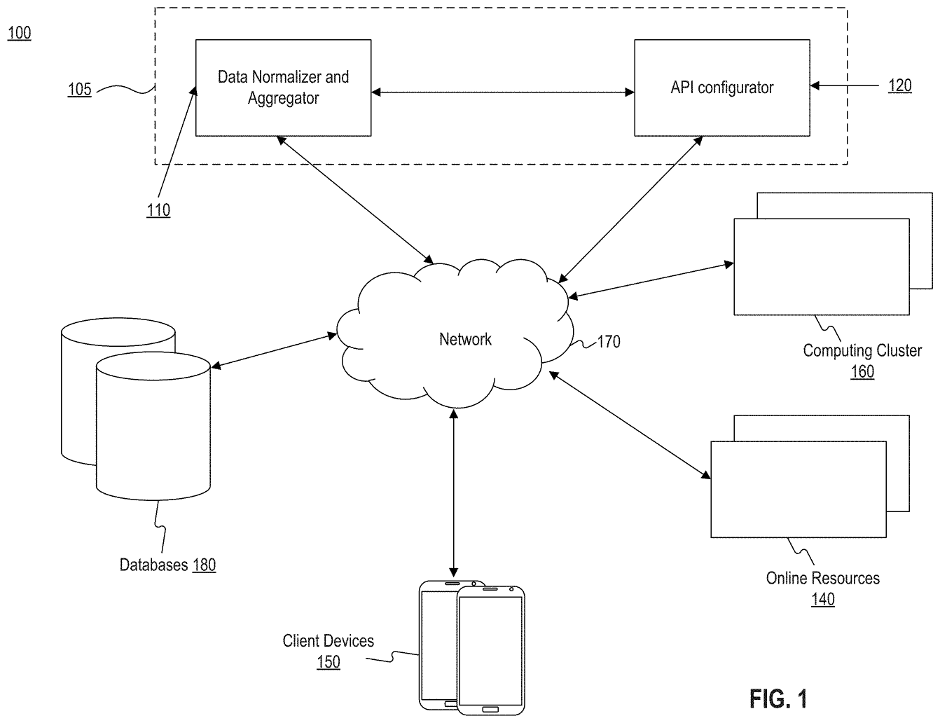

FIG. 1 is a block diagram of an exemplary system 100, in accordance with disclosed embodiments. System 100 may be configured to integrate real estate data from a plurality of sources to generate centralized service platforms that allow facilitate interactions between multiple parties in a real estate operation. System 100 may include an integration system 105 which may include document normalizer and aggregator (DNAA) 110 and an API configurator 120. System 100 may additionally include online resources 140, client devices 150, computing cluster 160, and databases 180. In some embodiments, as shown in FIG. 1, each component of system 100 may be connected to a network 170. However, in other embodiments components of system 100 may be connected directly with each other, without network 170.

Online resources 140 may include one or more servers or storage services provided by an entity such as a provider of website hosting, networking, cloud, or backup services. In some embodiments, online resources 140 may be associated with hosting services or servers that store web pages of real estate services and/or vendors with web pages containing information about properties. In other embodiments, online resources 140 may be associated with a cloud computing service such as Microsoft Azure™ or Amazon Web Services™. In yet other embodiments, online resources 140 may be associated with a messaging service, such as, for example, Apple Push Notification Service, Azure Mobile Services, or Google Cloud Messaging. In such embodiments, online resources 140 may handle the delivery of messages and notifications related to functions of the disclosed embodiments, such as image compression, notification of identified tasks or ticket alerts, and/or completion messages and notifications.

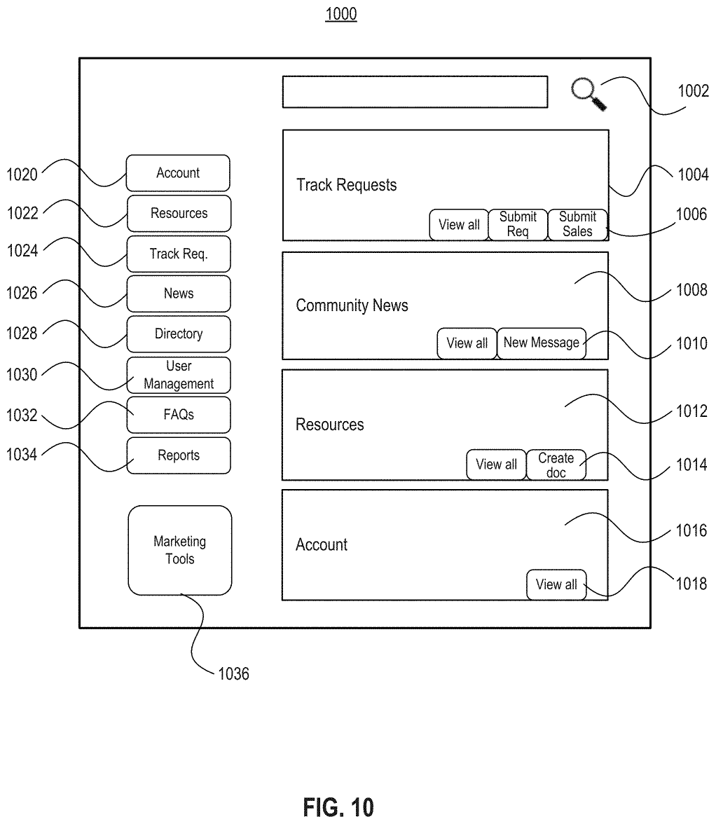

Client devices 150 may include one or more computing devices configured to perform one or more operations consistent with disclosed embodiments. For example, client devices 150 may include a desktop computer, a laptop, a server, a mobile device (e.g., tablet, smart phone, etc.), a gaming device, a wearable computing device, or other type of computing device. Client devices 150 may include one or more processors configured to execute software instructions stored in memory, such as memory included in client devices 150. Client devices 150 may include software that when executed by a processor, performs Internet-related communication and content display processes. For instance, client devices 150 may execute browser software that generates and displays interfaces including content on a display device included in, or connected to, client devices 150. Client devices 150 may execute applications that allows client devices 150 to communicate with components over network 170, and generate and display content in interfaces via display devices included in client devices 150. The display devices may be configured to display graphical user interfaces described in connection with FIGS. 10-16. The disclosed embodiments are not limited to any particular configuration of client devices 150. For instance, a client device 150 may be a mobile device that stores and executes mobile applications that provide functions offered by integration system 105 and/or online resources 140, such as providing real estate data in a databases 180 or accessing server information using APIs. In certain embodiments, client devices 150 may be configured to execute software instructions relating to location services, such as GPS locations. For example, client devices 150 may be configured to determine a geographic location and provide location data and time stamp data corresponding to the location data.

Computer cluster 160 may include a plurality of computing devices in communication. For example, in some embodiments, computer cluster 160 may be a group of processors in communication through fast local area networks. In other embodiments, computer cluster 160 may be an array of graphical processing units configured to work in parallel as a GPU cluster. In such embodiments, computer cluster may include heterogeneous or homogeneous hardware. In some embodiments, computer cluster 160 may include a GPU driver for each type of GPU present in each cluster node, a Clustering API (such as the Message Passing Interface, MPI), and VirtualCL (VCL) cluster platform such as a wrapper for OpenCL™, that allows most unmodified applications to transparently utilize multiple OpenCL devices in a cluster. In yet other embodiments, computer cluster 160 may operate with distcc, and MPICH, Linux Virtual Server, Linux-HA, or other director-based clusters that allow incoming requests for services to be distributed across multiple cluster nodes.

Databases 180 may include one or more computing devices configured with appropriate software to perform operations consistent with providing integration system 105, API configurator 120, and DNAA 110 with data associated with real estate documents, real estate status, and stored information about real estate operations or requests. Databases 180 may include, for example, Oracle™ databases, Sybase™ databases, or other relational databases or non-relational databases, such as Hadoop™ sequence files, HBase™, or Cassandra™. Database(s) 180 may include computing components (e.g., database management system, database server, etc.) configured to receive and process requests for data stored in memory devices of the database(s) and to provide data from the database(s).

While databases 180 are shown separately, in some embodiments databases 180 may be included in or otherwise related to one or more of integration system 105, DNAA 110, API configurator 120, and/or online resources 140.

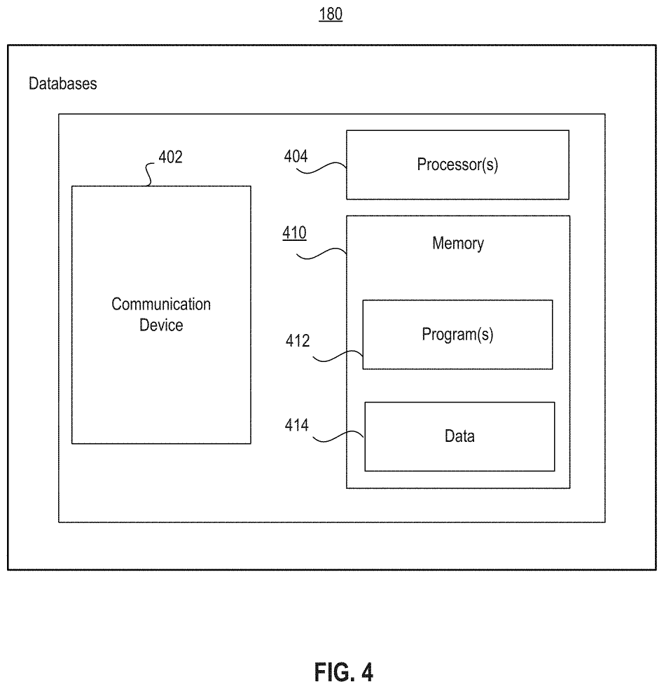

Databases 180 may be configured to collect and/or maintain specific data structures storing information associated with real estate properties, owners or tenants request, or information extracted from documents. In such embodiments, databases 180 may provide this information to the integration system 105, API configurator 120, and client devices 150. Databases 180 may collect the data from a variety of sources including, for instance, online resources 140. Databases 180 are further described below in connection with FIG. 4.

API configurator 120 may include hardware and/or software configured to search databases. API configurator 120 may receive or obtain information from databases 180, computer cluster 160, and online resources 140. For example, API configurator 120 may receive a plurality of documents from databases 180 and online resources 140. API configurator 120 may also receive data from client devices 150.

In some embodiments, API configurator 120 may receive requests from DNAA 110 to access servers and/or place requests. As a response to the request, API configurator 120 may set up an API with API Gateway by, for example, writing a request handler, installing an access to computing platforms, and creating an API in API Gateway, and connecting the access to a resource and method.

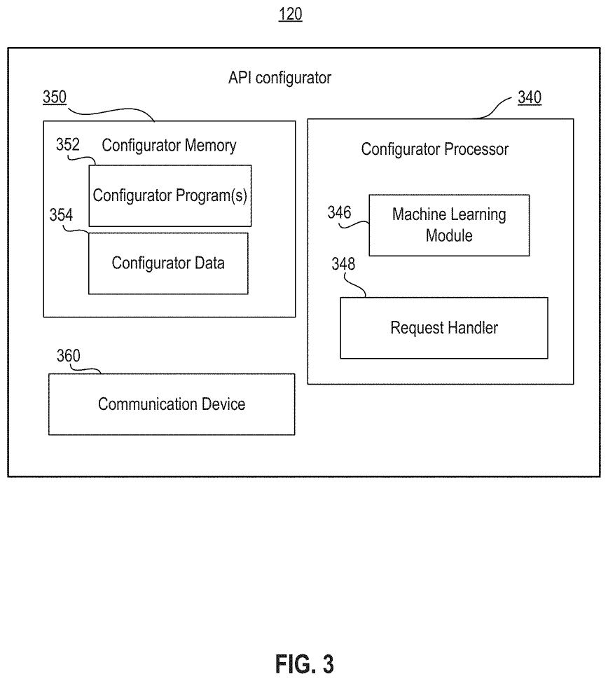

In some embodiments, API configurator 120 may use machine learning methods and develop functions to correlate information and automate configuration of API and API gateways. For example, API configurator 120 may employ convolutional neural networks (CNNs) or Random Forests to identify patterns of access and automate API configurations. In such embodiments, CNNs may include a plurality of nodes that may be associated with activation functions and be connected with other nodes via synapses that are associated with a weight. The CNNs may model input/output relationships of variables associated with real estate property and parameters by generating a number of interconnected nodes which contain an activation function. The activation function of a node may define a resulting output of that node given an argument or a set of arguments. With such configuration, CNNs may generate patterns to the network via an “input layer,” which communicates to one or more “hidden layers” where the system determines regressions via weighted connections. API configurator 120 may also utilize Random Forests, composed of a combination of decision tree predictors. (Decision trees may include a data structure mapping observations about something, in the “branch” of the tree, to conclusions about that thing's target value, in the “leaves” of the tree.) Each tree may depend on the values of a random vector sampled independently and with the same distribution for trees in the forest. Identification models may additionally or alternatively include classification and regression trees, or other types of models known to those skilled in the art. API configurator 120 may generate connectivity models and may analyze data stored in databases 180 to automate API configurations to connect with servers of system 100. API configurator 120 is further described below in connection with FIG. 3.

DNAA 110 may include one or more computing systems configured to perform one or more operations consistent with collecting, normalizing, and analyzing data to generate searchable data structures. In some embodiments, DNAA 110 may receive requests or documents from client devices 150, correlate users with a property using databases 180, and establish relationships between requests and properties. In some embodiments, DNAA 110 may also use machine learning techniques, previously disclosed, to collect and normalize real estate data. Further, DNAA 110 may also use convert operations of data formats and provide remote access to information. For example, in addition to collecting and normalizing data, DNAA 110 may also resolve user information data requests. In such embodiments, DNAA 110 may be configured to identify roles of users, determine their access level, and provide information and/or editing permissions based on their accessibility capabilities. Moreover, DNAA 110 may broadcast information and/or create centralized data platforms that leverage the integrated real estate data to provide communications between users of system 100.

FIG. 1 shows DNAA 110 and API configurator 120 as different components. However, in some embodiments, DNAA 110 and API configurator 120 may be implemented in the same computing system. For example, elements in integration system 105 may be embodied in a single server.

Network 170 may be any type of network configured to provide communications between components of system 100. For example, network 170 may be any type of network (including infrastructure) that provides communications, exchanges information, and/or facilitates the exchange of information, such as the Internet, a Local Area Network, near field communication (NFC), optical code scanner, or other suitable connection(s) that enables the sending and receiving of information between the components of system 100. In other embodiments, one or more components of system 100 may communicate directly through a dedicated communication link(s).

It is to be understood that the configuration and boundaries of the functional building blocks of system 100 have been defined herein for the convenience of the description. Alternative boundaries can be defined so long as the specified functions and relationships thereof are appropriately performed. Alternatives (including equivalents, extensions, variations, deviations, etc., of those described herein) may be apparent to persons skilled in the relevant art(s) based on the teachings contained herein. Such alternatives fall within the scope and spirit of the disclosed embodiments.

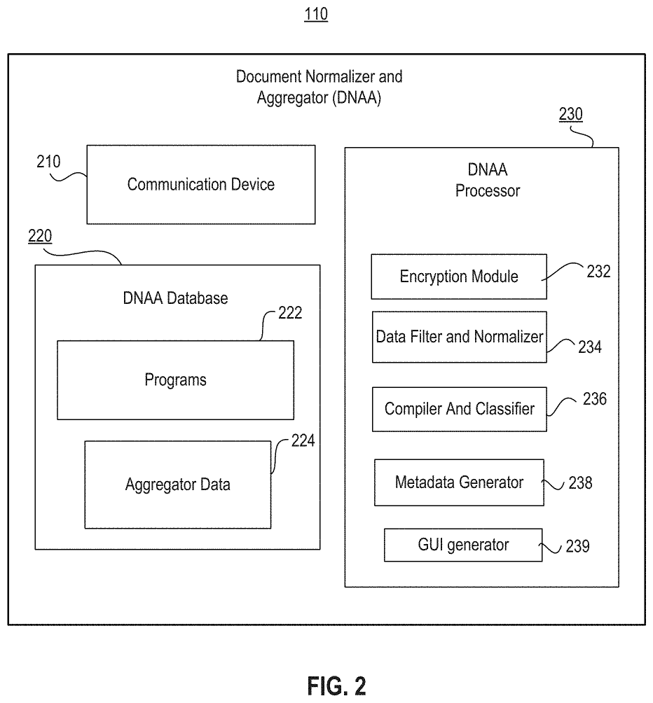

FIG. 2 is a block diagram of an exemplary document normalizer and aggregator (DNAA) 110, in accordance with disclosed embodiments. DNAA 110 may include a communication device 210, a DNAA database 220, and one or more DNAA processors 230. DNAA database 220 may include programs 222 and aggregator data 224. DNAA processor 230 may include encryption module 232, data filter and normalizer 234, compiler and classifier 236, and metadata generator 238.

In some embodiments, DNAA 110 may take the form of a server, general purpose computer, mainframe computer, or any combination of these components. In other embodiments, DNAA 110 may be a virtual machine and/or be solely implemented with software.

Communication device 210 may be configured to communicate with one or more databases, such as databases 180 described above in connection with FIG. 1. In particular, communication device 210 may be configured to receive documents and/or data files from API configurator 120 or client devices 150. In addition, communication device 210 may be configured to communicate with other components of system 100 including, for example, online resources 140. Communication device 210 may include, for example, one or more digital and/or analog devices that allow communication device 210 to communicate with and/or detect other components, such as a network controller and/or wireless adaptor for communicating over the Internet.

In some embodiments, DNAA 110 may communicate with client devices 150 over a secure connection. For example, communications between client devices 150 and integration system 105 may use secure sockets layer (SSL) protocols. In such embodiments, DNAA 110 may perform identification and authentication functions. For example, DNAA 110 may resolve concatenated passwords, that include added strings to the actual password.

Alternatively, or additionally, access to DNAA 110 may be protected with spring security. Spring security may include highly customizable authentication and access-control framework to provide a security framework that provides authentication and authorization support in order to Secure Spring-based applications. This may help with a comprehensive and extensible support for both Authentication and Authorization and may provide protection against attacks like session fixation, clickjacking, cross site request. Further, access to DNAA 110 may utilize passwords that require a minimum size and complexity for the password.

DNAA database 220 may include one or more storage devices configured to store instructions used by DNAA processor 230 to perform functions related to disclosed embodiments. For example, DNAA database 220 may store software instructions, such as program 222, that may perform one or more operations when executed by DNAA processor 230. The disclosed embodiments are not limited to separate programs or computers configured to perform dedicated tasks. For example, DNAA database 220 may include a single program 222 that performs the functions of DNAA 110, or program 222 may include multiple programs. DNAA database 220 may also store aggregator data 224 that is used by program(s) 222.

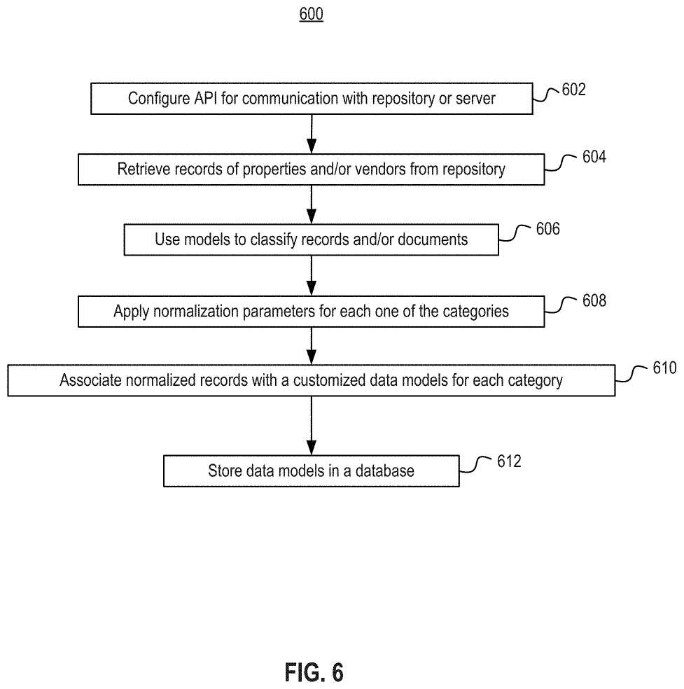

In certain embodiments, DNAA database 220 may store sets of instructions for carrying out processes normalize real estate data or identify the role of one of client devices 150 requesting access to information, as further described in connection to FIGS. 6-8.

In some embodiments, DNAA processor 230 may include one or more known processing devices, such as, but not limited to, microprocessors from the Pentium™ or Xeon™ family manufactured by Intel™, the Turion™ family manufactured by AMD™, or any of various processors from other manufacturers. However, in other embodiments, DNAA processor 230 may be a plurality of devices coupled and configured to perform functions in accordance with the disclosure.

DNAA processor 230 may include an encryption module 232, a data filter and normalizer 234, a compiler and classifier 236, and a metadata generator 238. In some embodiments, DNAA processor 230 may execute software to perform functions associated with each component of DNAA processor 230. In other embodiments, each component of DNAA processor 230 may be an independent device. In such embodiments, each component may be hardware configured to specifically process data. For example, encryption module 232 may be a field-programmable gate array (FPGA), data filter and normalizer 234 may be a Graphics processing unit (GPU), and compiler and classifier 236 may be a central processing unit (CPU). Other hardware combinations are also possible. In yet other embodiments, combinations of hardware and software may be used to implement DNAA processor 230.

Encryption module 232 may include hardware and/or software configured to perform encryption operations on data structures generated by DNAA 110 and/or documents or information collected by DNAA 110. Encryption module 232 may perform encryption operations by using a key and then transmit the encrypted information over an untrusted network. Encryption module 232 may employ two types of encryption, symmetric and asymmetric. In symmetric encryption, encryption module 232 may use the same data key to encrypt and decrypt the information. Various types of symmetric encryption which are known in the art include the Data Encryption Standard (DES), the Improved DES (IDES), and/or the RC-5 algorithm. Alternatively, or additionally, encryption module 232 may use asymmetric encryption, in which a first key is used to encrypt the information and a second key is used to decrypt the information. In some embodiments, the first key is a public key which may be widely known and the second key is a private key which is known only to authorized clients. For example, an invoice from a rental property may be encrypted using a public key but may be only decrypted using a private key that is available only to specific users of client devices 150. In such embodiments, encryption module 232 may use asymmetric encryption methods including the Diffie-Hellmean algorithm.

Moreover, encryption module 232 may allow sending information over an entrusted network is end-to-end encryption. For example, integration system 105 may send a data key to client devices 150 encrypted using a client key which is secret to the host and the client. Client devices 150 may decrypt the data key and hold the data key in a protected region of memory. Data transferred between integration system 105 and client devices 150 may be encoded at one end and decoded at the other end using the data key. The data key may be used throughout the entire information access session.

In some embodiments, DNAA processor 230 may perform capturing functions with data filter and normalizer 234. For example, data filter and normalizer 234 may be configured to extract features from a received documents and create new files with normalized features. In such embodiments, data filter and normalizer 234 may use deep learning models such as Fast R-CNN can be used for automatic feature extraction. In yet other embodiments, Histogram of Oriented Gradients (HOG), Speeded-Up Robust Features (SURF), Local Binary Patterns (LBP), Color histogram, and Haar wavelets may also be used to extract features from a received image.

DNAA processor 230 may implement data filter and normalizer 234 by executing software to create an environment for extracting image features. However, in other embodiments, data filter and normalizer 234 may include independent hardware with specific architectures to improve the efficiency of aggregation or sorting processes. For example, data filter and normalizer 234 may be a GPU array configured to partition and analyze layers in parallel. Alternatively, or additionally, data filter and normalizer 234 may be configured to implement a programming interface, such as Apache Spark, and execute data structures, cluster managers, and/or distributed storage systems. For example, data filter and normalizer 234 may include a resilient distributed dataset that is manipulated with a standalone software framework and/or a distributed file system.

In some embodiments, data filter and normalizer 234 may be configured to perform operations to extract machine readable content and generate searchable files. Data filter and normalizer 234 may extract content from records (including PDF, BMP, TIFF, JPEG, and PNG files), by first loading the files as image. Once the file is loaded, data filter and normalizer 234 may modify image quality and orientation by removing “noise” (a/k/a varying brightness or color) or straightening the image. Data filter and normalizer 234 may also remove lines that are in the full document to enhance quality of machine content extraction.

After processing the image, data filter and normalizer 234 may analyze the image to identify detection of text positions, white space, and the prioritization of important text areas or sections. For example, data filter and normalizer 234 may identify tables section to prioritize content extraction. Then, data filter and normalizer 234 may identify individual words and entire lines of data and fix “broken” or “merged” characters. Data filter and normalizer 234 may then recognize each character in the identified text to translate images to machine readable content. For example, records retrieved form the plurality of databases may be converted into a character code. Once machine readable content has been extracted from the records, data filter and normalizer 234 may save the extract content in a desired searchable format. For example, data filter and normalizer 234 may save the extracted content in XML files that may be used by compiler and classifier 236 to generate indexed files.

Compiler and classifier 236 may collect data from websites—like PDF documents or online real estate forms. In some embodiments, DNAA processor 230 may implement compiler and classifier 236 by executing instructions to create an application in which images are received and transformed. In other embodiments, however, compiler and classifier 236 may be a separate device or group of devices.

In some embodiments, compiler and classifier 236 may be configured for specific databases or sources. For example, compiler and classifier 236 may be configured to collect records from specific databases containing real estate information (e.g., MRI Software). In such embodiments, compiler and classifier 236 may implement a series of rules to extract information from the specific database. The rules may apply to websites, documents, and/or online forms and may include matching basic key.

Rules for compiler and classifier 236, or similar tools to retrieve information from databases 180 or online resources 140 and may employ keywords or trends. Alternatively, or additionally, DNAA processor 230 may request information by request API configurator 120 to retrieve records from the multiple databases including real estate records.

Compiler and classifier 236 may also organize information retrieved from records and compile instructions to execute aggregation tasks. For example, compiler and classifier 236 may use a categorization model and apply inputs based on a request from client device 150. Moreover, compiler and classifier 236 may index files and generate database entries to facilitate query resolutions. For example, compiler and classifier 236 may structure machine readable content with different categories to improve search efficiency. In such embodiments, compiler and classifier 236 may categorize extracted information based on different data structures associated with different properties or tasks.

In some embodiments, DNAA processor 230 may use metadata generator 238 to label records and/or extracted content to facilitate future searches or rank relevance of records. Metadata generator 238 may generate tags, such as HTML tags, that provide metadata about records. These meta tags may be used by DNAA 110 to help index and to provide relevant content in their search results. In some embodiments, DNAA 110 may use machine learning methods to classify documents or data files and label them with metadata generator 238.

Moreover, in some embodiments DNAA processor 230 may include a GUI generator 239. GUI generator 239 may generate user interfaces that display real estate data that has been normalized and aggregated. GUI generator 239 may include GUI builders based on pyqt and pyqtgraph. In such embodiments, GUI generator 239 may generate GUIs based on availability of screen space on client devices 150. GUI generator 239 may configure layouts that expose only the most commonly-used objects so users of client devices 150 do not need to sift through long lists of methods and properties. Alternatively, or additionally, GUI generator 239 may include a GUI builder for Python Tkinter that generates windows with forms, buttons, labels, etc. GUI generator 239 may be configurable to produce GUIs for mobile devices (i.e., compatible with iOS™ and Android™), for web browsers, and/or desktop computers.

The components of DNAA 110 may be implemented in hardware, software, or a combination of both, as may be apparent to those skilled in the art. For example, although one or more components of DNAA 110 may be implemented as computer processing instructions embodied in computer software, all or a portion of the functionality of DNAA 110 may be implemented in dedicated hardware. For instance, groups of GPUs and/or FPGAs may be used to quickly analyze data in DNAA processor 230.

FIG. 3 is a block diagram of an exemplary API configurator 120, in accordance with disclosed embodiments. API configurator 120 may include a configurator processor 340, a configurator memory 350, and a communication device 360.

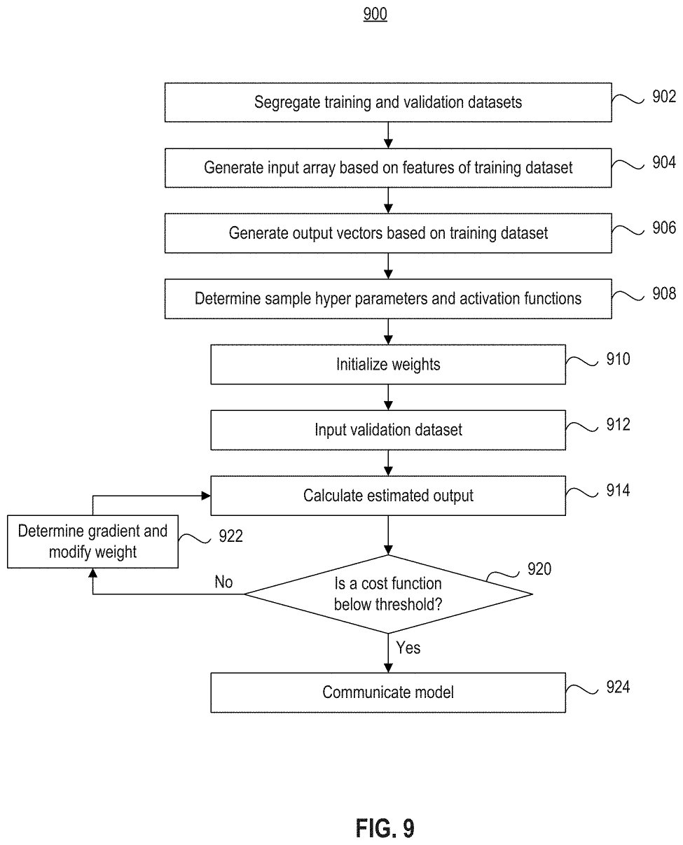

Configurator processor 340 may include a processor similar to DNAA processor 230. Configurator processor 340 may include a machine learning module 346 and a request handler 348. Machine learning module 346 may be software or hardware configured to create identification models based on training data. For example, machine learning module 346 may perform operations to generate predictive models or clustering algorithms or clustering techniques such as K-means clustering, mean-shift clustering, DBSCAN, or other similar techniques, as further described in connection with FIG. 9.

Request handler 348 may be software or hardware configured to compile and execute JavaScripts to initialize APIs that allow accessing other systems. Request handler 348 may perform the following JavaScript to initialize the configuration of APIs:

Mkdir NewApi
touch lib/new_api.js test/my_new_api_test.js index.js package.json
{“name” : “myNewApi”, “version”: “0.0.1”' “description”; “autoAPI”, “main”; “index.js”}
devDependencies: {“P1”: “*”, “P2”: “*”},
“scripts”: {“zip”: “zip -r ../NewApi.zip * ”}

Request handler 348 may also establish a controller mode that allows configurator processor 340 to invoke virtual machines or distributions (such as Linux distributions related to RHEL). Request handler 348 may load a config file and invoke a function that passes an event (a JS object containing the JSON-decoded request body), config (a JS object loaded from our config file) and a Node-style callback of the form function (err, responseObject). For example, request handler 348 may perform functions such as:

var package = require( “./package.json”);
var NewApi = require (“./lib/my_new_api.js”);
console.log(“loaded” + “package.name + “, version” + package.version);
exports.handler = function (event, context) {myNewApi.handleRequest(event, context.done);}

In some embodiments, request handler 348 may also run testing of configured APIs. For example, request handler 348 may perform operations such as:

var assert = require (“chai”).assert;
var NewApi = require(“../lib/my_new_api.js”);
describe(“NewApi”, function () { it(“exports handleRequest”, function () {
assert.typeOf(Api.handleRequest, “function”).

In some embodiments, request handler 348 may also set up an API Gateway. Moreover, request handler 348 may create the API and automatically give it a name and description. Further request handler 348 may create API methods, which may include a combination of “resources” (paths) and an HTTP methods for request and responses. API methods generated by request handler 348 may provide basic building blocks of the API. In some embodiments, request handler 348 may create methods such as a POST method or a GET method.

Configurator memory 350 may perform authentication tasks when API configurator 120 gets coupled with other elements of system 100. For example, configurator memory 350 may store information of certain systems to compare the digital footprint of messages received from a system. Configurator memory 350 may also include configurator programs 352 that store instructions for configurator processor 340 to generate APIs and/or configure APIs. Further, configurator memory 350 may include configurator data 354, which may store previously set up APIs. In this way, API configurator 120 may retrieve APIs and/or their configurations that were previously determined for recurring connections. For example, integration system 105 may frequently contact a system of a roofing vendor to request information. In such situations, configurator data 354 may store information of APIs to access information from the roofing vendor system or a specific one of the online resources 140.

FIG. 4 is a block diagram of an exemplary databases 180, in accordance with disclosed embodiments. Databases 180 may include a communication device 402, one or more database processors 404, and database memory 410 including one or more database programs 412 and data 414.

In some embodiments, databases 180 may take the form of servers, general purpose computers, mainframe computers, or any combination of these components. Other implementations consistent with disclosed embodiments are possible as well.

Communication device 402 may be configured to communicate with one or more components of system 100, such as online resource 140, integration system 105, API configurator 120, and/or client devices 150. In particular, communication device 402 may be configured to provide to DNAA 110 documents and real estate data to generate data in standard formats and/or searchable data structures that can be used for visualization.

Database processors 404, database memory 410, database programs 412, and data 414, may take any of the forms described above for DNAA processors 230, DNAA database 220, programs 222, and aggregator data 224, respectively. The components of databases 180 may be implemented in hardware, software, or a combination of both hardware and software, as may be apparent to those skilled in the art. For example, although one or more components of databases 180 may be implemented as computer processing instruction modules, all or a portion of the functionality of databases 180 may be implemented instead in dedicated electronics hardware.

Data 414 may be data associated with real estate electronic records. For example, databases 180 may include a searchable database of real estate records. In such embodiments, databases 180 may be used to search by individual property or pending tasks.

In some embodiments, databases 180 may be implemented with open-source software and distributed computing. For example, databases 180 may be implemented with Apache Hadoop™ software libraries to create a framework that allows for the distributed processing of large data sets. Further, databases 180 may use indexing processes (e.g., Solr™) on a server to facilitate future searches. In some embodiments, databases 180 may index information retrieve from records by DNAA processor 230 (FIG. 2) to facilitate future searches. Moreover, databases 180 may include proprietary databases with cleaned and transformed real estate

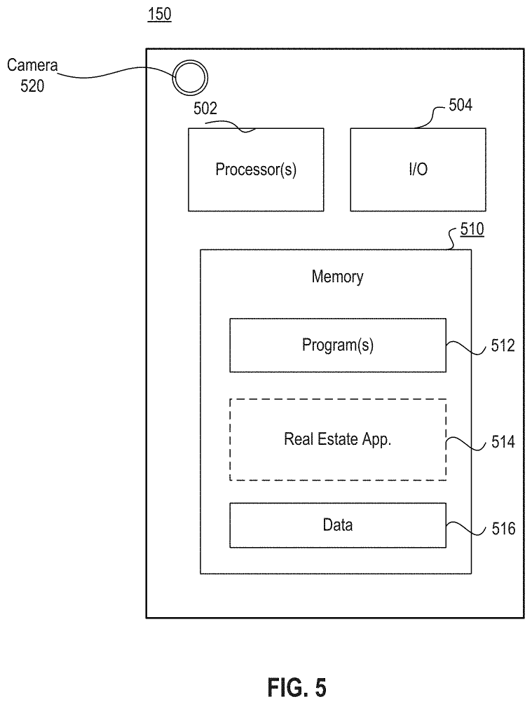

FIG. 5 is a block diagram of an exemplary client device 150, in accordance with disclosed embodiments. In one embodiment, client devices 150 may include one or more processors 502, one or more input/output (I/O) devices 504, and one or more memories 510. In some embodiments, client devices 150 may take the form of mobile computing devices such as smartphones or tablets, general purpose computers, or any combination of these components. Alternatively, client devices 150 (or systems including client devices 150) may be configured as a particular apparatus, embedded system, dedicated circuit, and the like, based on the storage, execution, and/or implementation of the software instructions that perform one or more operations consistent with the disclosed embodiments. According to some embodiments, client devices 150 may include web browsers or similar computing devices that access websites consistent with disclosed embodiments.

Processor 502 may include one or more known processing devices, such as mobile device microprocessors manufactured by Intel™, NVIDIA™, or various processors from other manufacturers. The disclosed embodiments are not limited to any specific type of processor configured in client devices 150.

Memory 510 may include one or more storage devices configured to store instructions used by processor 502 to perform functions related to disclosed embodiments. For example, memory 510 may be configured with one or more software instructions, such as programs 512 that may perform one or more operations when executed by processor 502. The disclosed embodiments are not limited to separate programs or computers configured to perform dedicated tasks. For example, memory 510 may include a single program 512 that performs the functions of the client devices 150, or program 512 may include multiple programs. Memory 510 may also store data 516.

In certain embodiments, memory 510 may store a real estate application 514 that may be executed by processor(s) 502 to retrieve and display integrated real estate data consistent with disclosed embodiments. In certain aspects, real estate application 514, or another software component, may be configured to request information from integration system 105 or determine the location of client devices 150.

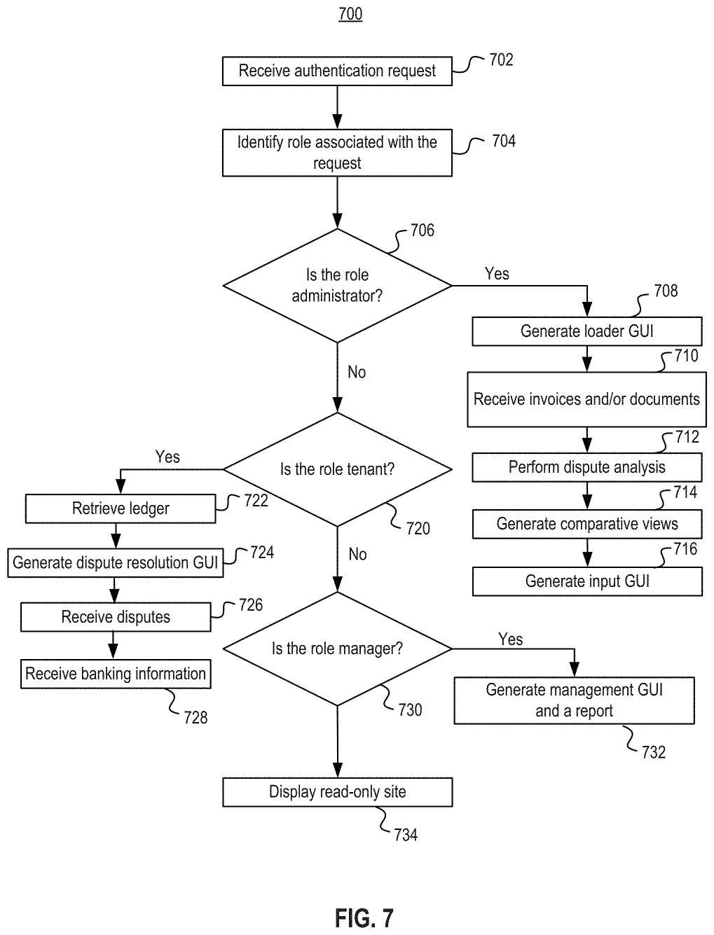

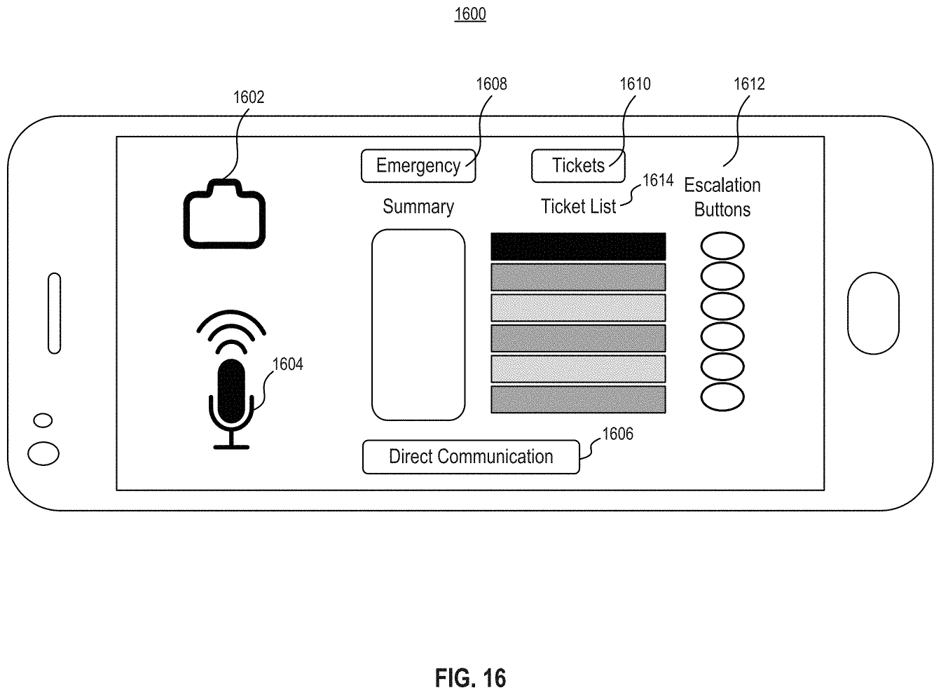

In some embodiments, real estate application 514 may connect a mobile device with integration system 105 allowing access to records of integration system 105 or allow accessing functions of integration system 105. For example, through real estate application 514 client devices 150 may retrieve records associated with properties from integration system 105. Alternatively, or additionally, through real estate application 514 client devices 150 may submit requests associated with a property, query account information, review news and announcements, and receive or transmit emergency messages. Further, real estate application 514 may permit mobile client devices 150 to upload information, track requests, and review reports. In such embodiments, real estate application 514 may be configured to display GUIs as further described in connection to FIGS. 7 and 16.

I/O devices 504 may include one or more devices configured to allow data to be received and/or transmitted by client devices 150 and to allow client devices 150 to communicate with other machines and devices, such as other components of system 100. For example, I/O devices 504 may include a screen for displaying optical payment methods such as Quick Response Codes (QR), or providing information to the user. I/O devices 504 may also include components for NFC communication. I/O devices 504 may also include one or more digital and/or analog devices that allow a user to interact with client devices 150 such as a touch-sensitive area, buttons, or microphones. I/O devices 504 may also include one or more accelerometers to detect the orientation and inertia of client devices 150. I/O devices 504 may also include other components known in the art for interacting with integration system 105.

In some embodiments, client devices 150 may include camera 520 that is configured to take images or video and send it to other component of system 100 via, for example, network 170.

The components of client devices 150 may be implemented in hardware, software, or a combination of both hardware and software, as may be apparent to those skilled in the art.

FIG. 6 is an exemplary flow chart illustrating a data integration process 600, in accordance with disclosed embodiments. In some embodiments, process 600 may be executed by integration system 105. For example, DNAA 110 may perform steps in process 600. In other embodiments, however, process 600 may be performed by client devices 150. For example, processor 502 in client devices 150 may execute instructions in real estate application 514 (FIG. 5) to perform process 600. Further, in some embodiments process 600 may be performed by multiple elements of system 100. For example, some steps of process 600 may be performed by integration system 105, while other steps of process 600 may be performed by client devices 150.

The description of process 600 below illustrates an embodiment in which integration system 105 performs steps of process 600. However, as previously discussed, other elements of system 100 may also be configurable to perform one or more of the steps in process 600. For example, client devices 150, and in particular processor(s) 502 may perform one or more steps of process 600.

In step 602, integration system 105 may configure an API for communication with a repository or server. For example, using API configurator 120, integration system 105 may recall or setup an API to connect with servers or repositories of information. In some embodiments, at step 602 integration system 105 may configure an API to collect information from vendors of real estate properties. Alternatively, or additionally, integration system 105 may configure APIs to couple with property management and accounting software. With such APIs, integration system 105 may automatically gain access to financial operations, budgeting, forecasting, facility management, general ledger, job costing, reporting, accounts payable. Integration system 105 may also gain access to information of strategic planning for investment analysis, portfolio analysis, fund and asset modeling. Further, APIs may allow integration system 105 to connect with servers containing information of commercial management, lease accounting, operations, financials, advanced retail and lease work flow, and compliance management.

In step 604, integration system 105 may retrieve records of properties and/or vendors. In some embodiments, integration system 105 may use APIs configured in step 602 to retrieve access about certain properties. For example, integration system may use an API configured to automatically receive updates from vendors systems. In certain embodiments, retrieving vendors in step 604 may include categorizing vendors based on a preferred vendor list. For example, integration system 105 may store a ranking of vendors in databases 180 (FIG. 1). In such embodiments, integration system may determine preferred vendors at step 604 and retrieve records from preferred vendors only or modify the records based on the vendor position. Alternatively, or additionally, the preferred vendor list may be dynamically generated. For example, integration system 105 may periodically update the preferred vendor list based on time of the year, reviews, prices, and/or complaints.

In step 606, integration system 105 may classify documents or records received in step 604. For example, integration system 105 may use machine learning algorithms to classify or categorize documents received from servers or repositories associated with a real estate property. The classification may include whether the document is associated with a request, with changes in asset information, with financial information, among others. This classification may facilitate later analysis of data by grouping similar data with each other so similar analytics methods can be employed. For example, in step 606 integration system 105 may categorize documents received from vendor systems in one or more categories such as request information, financial information, and/or marketing information.

In step 608, integration system 105 may apply normalization parameters for each one of the categories of step 606. For example, integration system 105 may apply normalization rules to the documents categorized as financial information. Then, a set of rules that may normalize data fields such as numbering formats, or timelines, may be employed to normalize formats. Further, in step 608 the normalization may include changing file formats. For instance, integration system 105 may normalize formats of ODS—OpenDocument spreadsheet, SDC—StarOffice StarCalc Spreadsheet, TAB—tab delimited columns; also TSV (Tab-Separated Values), XLS—Microsoft Excel worksheet sheet (97-2003), XLSX—Office Open XML worksheet sheet, into a single CSV—Comma-Separated Values. This normalization of data files may facilitate later data analytics and visualization.

In step 610, integration system 105 may associate normalized records with a customized data model for each category. In some embodiments, integration system 105 may take normalized information an apply a data model that is different for each type of user. For example, records associated with users with multiple real estate properties, integration system 105 may generate a data model that allows specific interactions with the users. If, instead, integration system 105 determines that a user associated with a record does not have many properties, integration system 105 may store the record under a different data models. The data models employed in step 610 may have different architectures and may be associated with different data structures.

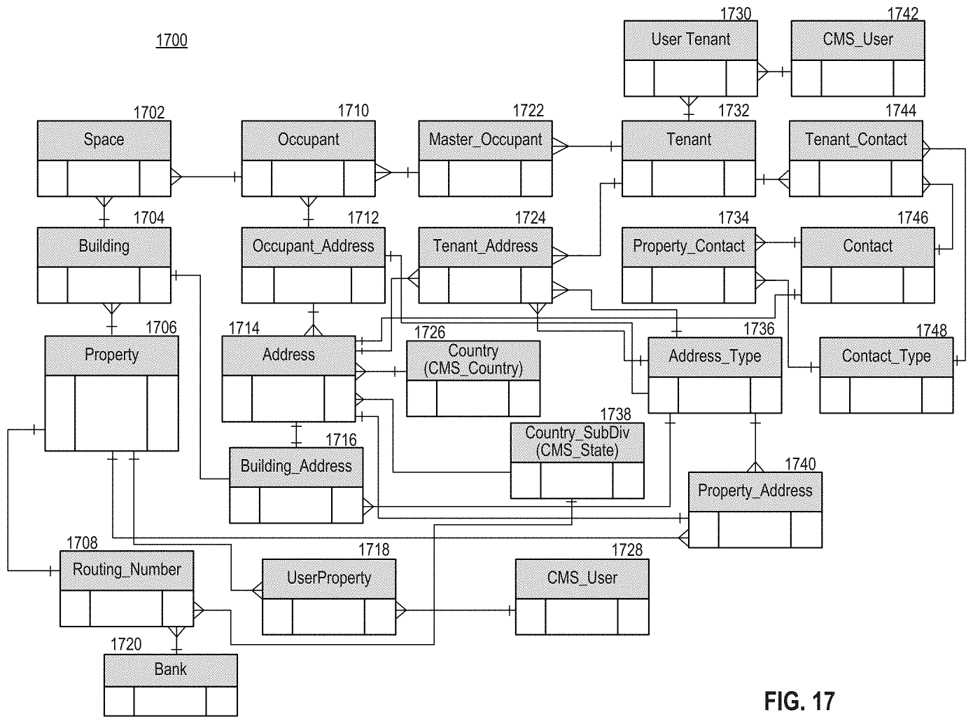

Employing multiple data models may allow integration system 105 to manage properties, accessibility of data, make granularized assessments for costs and projections, and determine connectivity between different entities. As further described in connection to FIGS. 17-21, data models may specify interactions between different objects in integration system 105. In such embodiments, objects may be modeled with tables and/or memory positions storing parameters, variables, and pre-programmed responses.

In step 612, integration system 105 may store the data models generated in step 610. For example, integration system 105 may store data models in databases 180 (FIG. 1). In such embodiments, integration system 105 may store the data models for each one of the properties using specific data structures that facilitate search and visualization.

FIG. 7 is an exemplary flow chart illustrating an access granting process 700, in accordance with disclosed embodiments. In some embodiments, process 700 may be executed by integration system 105. In other embodiments, however, process 700 may be performed by databases 180. For example, processor 404 in databases 180 may execute instructions in programs 412 to perform process 700. In other embodiments, process 700 may be performed by multiple elements of system 100.

The description of process 700 below illustrates an embodiment in which integration system 105 performs steps of process 700. However, as previously discussed, other elements of system 100 may also be configurable to perform one or more of the steps in process 700.

In step 702, integration system 105 may receive an authentication request. The authentication request may include credentials of a user, such as name and password. Alternatively, or additionally, the authentication request may include information of client devices 150, like their location, associated MAC address, or other digital footprints. Further, in some embodiments the authentication request in step 702 may be received from a single sign-on (SSO) system. For example, integration system 105 may be connected to multiple related but independent software systems. In such embodiments, integration system 105 may execute an SSO system that allows users to log in with a single ID and password to gain access to multiple services provided by integration system 105. In such embodiments, integration system 105 may employ Lightweight Directory Access Protocol (LDAP) and stored LDAP databases on (directory) servers to enable SSO operations. Alternatively, or additionally, integration system 105 may allow users to use a single authentication by passing authentication tokens between different applications. In such embodiments, as different applications and resources support different authentication mechanisms, integration system 105 may internally store the credentials used for initial authentication and translate them to the credentials required for the different mechanisms. In some embodiments, integration system 105 may apply different SSD schemes such as OpenID or OpenID Connect.

In step 704, integration system 105 may identify a role associated with the request. Integration system 105 may first determine if the user that generated the request has the correct credentials and then correlate the user with some role by, for example, querying databases 180.

In step 706, integration system 105 may determine whether the role identified in step 704 is administrator. If integration system 105 determines the role is administrator (step 706: Yes), integration system 105 may continue to step 708 and generate a loader GUI. For example, integration system 105 may employ GUI generator 239 to generate a GUI for client devices that allow uploading documents. In some embodiments the loader GUI may allow to upload requests, documents, or communications. In step 710, integration system 105 may receive invoices and/or documents. For example, integration system 105 may receive documents uploaded via the loader GUI of step 708.

In step 712, integration system 105 may perform a dispute analysis of the documents. For example, integration system 105 may compare invoices and requests to identify inconsistencies. In step 714, integration system 105 may generate comparative views that may allow the users to identify inconsistencies. In step 716, integration system 105 may generate an input GUI where a user, that has been identified as an administrator, may input information correcting inconsistencies and/or generating alerts or messages.

If in step 706 integration system 105 determines that the role is not administrator (step 706: No), integration system 105 may continue to step 720. In step 720, integration system 105 may determine whether the role of the user is a tenant. If integration system 105 determines the role is for a tenant (step 720: Yes), integration system 105 may continue to step 722 and retrieve a ledger with information associated with the corresponding tenant. The ledger may be used to generate a dispute resolution GUI. For example, using GUI generator 239 (FIG. 2), integration system 105 may generate a GUI that displays some of the ledger information that may be in dispute when for example, the dispute analysis of step 712 determines there are inconsistencies. In step 726, integration system 105 may receive disputes via the resolution GUI and in step 728 integration system 105 may receive banking information to resolve the dispute.

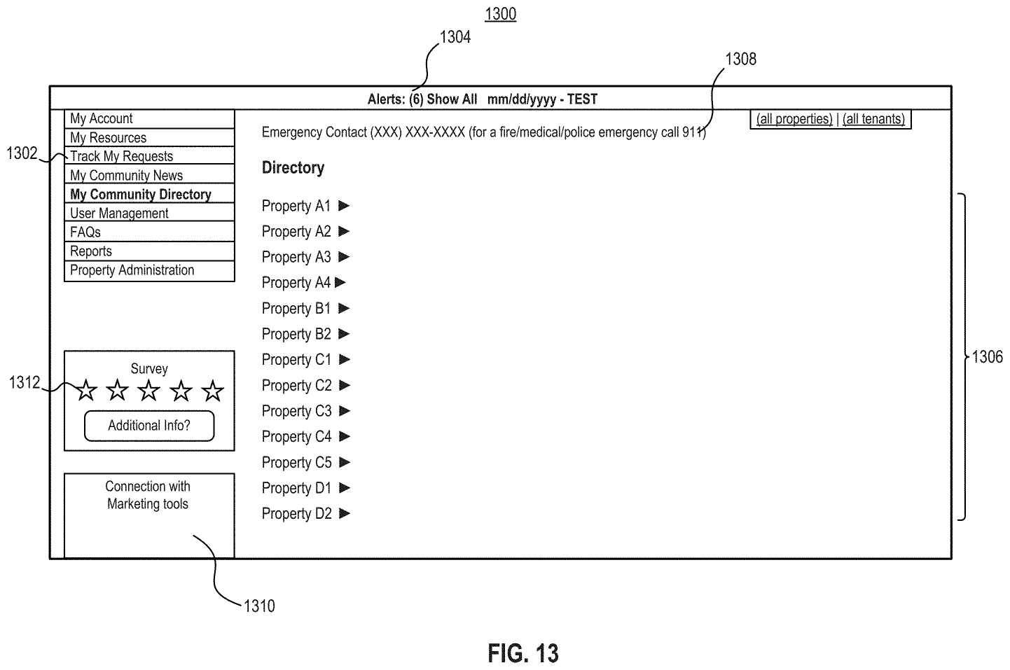

If in step 730 integration system 105 determines that the role is not tenant (step 720: No), integration system 105 may continue to step 730. In step 730, integration system 105 may determine whether the user associated with the authentication request is a manager role. If integration system 105 determines that the role is manager (step 730: Yes), integration system 105 may continue to step 732 and generate a management GUI and a report. For example, as further described in connection with FIG. 13, integration system 105 may generate a GUI that lists properties and provide reports of their status, client requests, and pending interactions.

If in step 730 integration system 105 determines that the role is not manager (step 730: No), integration system 105 may continue to step 734 and display a read-only site.

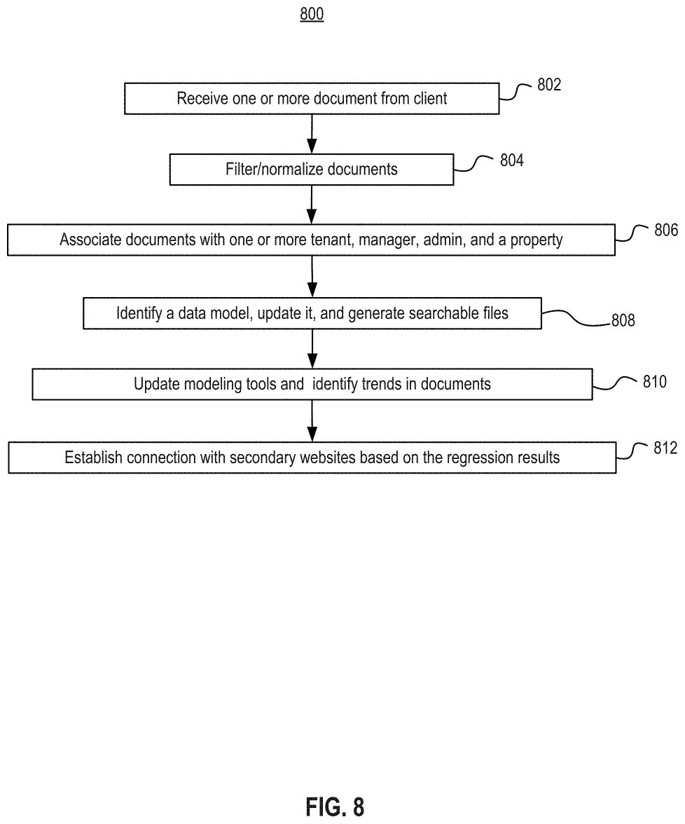

FIG. 8 is an exemplary flow chart illustrating document analysis process 800, in accordance with disclosed embodiments. In some embodiments, process 800 may be executed by integration system 105. For example, DNAA 110 may perform steps in process 800. In other embodiments, however, process 800 may be performed by client devices 150. Further, in some embodiments process 800 may be performed by multiple elements of system 100.

The description of process 800 below illustrates an embodiment in which integration system 105 performs steps of process 800. However, as previously discussed, other elements of system 100 may also be configurable to perform one or more of the steps in process 800.

In step 802, integration system 105 may receive one or more documents from a client. For example, integration system 105 may receive invoices from client devices 150. In step 804, integration system 105 may filter and/or normalize documents. For example, using DNAA 110 integration system 105 may categorize data, filter data, and apply normalization rules to generate standardized formats that facilitate analysis.

In step 806, integration system 105 may associate documents with one or more tenants, managers, or administrators. For example, integration system 105 may determine whether the document was uploaded by a tenant and associate the document with a property.

In step 808, integration system 105 may identify a data model associated with the document, update the data model, and generate searchable files. For example, integration system 105 may correlate the document of step 802 with a data model for large tenants (i.e., with multiple properties). Based on the data model, integration system 105 may update the data model and use the updated model to generate searchable files that are used to provide information to users of client devices 150.

In step 810, integration system 105 may incorporate the document of step 802 into modeling tools and identify trends. For example, using machine learning algorithms integration system 105 may model requests with linear regressions to identify future requests or estimate price points that a user may be interested to learn. Trends discovered in step 810 may allow integration system 105 to integrate property management software, identify demographic trends for marketing purposes, and predict rental market demand: Based on the integrated data collected, with for example process 600, integration system may generate tools that allow property managers to improve user interactions and facilitate communications.

In some embodiments, integration system 105 may use the identified trends of step 810 to establish connections with secondary websites based on the analysis results. For example, it the trends identified indicate that roofing services will be required for a property in the near future, integration system 105 may use API configurator 120 to connect with a roofing company server and place a request in advance, Alternatively, or additionally, if integration system 105 determines that a tenant is likely to leave in the near future, integration system 105 may connect with marketing or social media websites to start searching for new tenants.

The ability to retrieve, normalize, and analyze documents to identify trends using machine learning algorithms, may allow integration system 105 to automate processes and provide insights to system managers. Further, the ability to identify trends may also facilitate communications with different users, under different roles, of the system.

FIG. 9 is an exemplary flow chart illustrating a process 900 for generating a classification model, in accordance with disclosed embodiments. In some embodiments, process 900 may be executed by integration system 105. For example, API configurator 120 may perform steps in process 900. In other embodiments, however, process 700 may be performed by computer clusters 160. Alternatively, process 900 may be performed by multiple elements of system 100.

The description of process 900 below illustrates an embodiment in which integration system 105 performs steps of process 900. However, as previously discussed, other elements of system 100 may also be configurable to perform one or more of the steps in process 900.

In step 902, integration system 105 may determine a training dataset and a validation dataset. For example, integration system 105 may partition real estate records into a training and a validation portions. Integration system 105 may receive data including a real estate data, such as invoices, service requests, or reports. The records may be associated with metadata describing attributes of the record and an associated property. Further, the records may be associated with one of the data models described in connection with FIG. 6. Integration system 105 may divide the records and generate two groups, one to train the predictive machine-learning model and a second to validate the model.

In step 904, integration system 105 may generate an input array based on features of the training dataset. For example, integration system 105 may generate a variable including feature information of transactions and/or records in the training dataset.

In step 906, integration system 105 may generate output vectors based on metadata of the training dataset. For example, based on the transactions in the training dataset, the identification system may generate a desired output vector making a prediction of, for example, likelihood that a request will be place by a user.

In step 908, integration system 105 may determine sample hyper-parameters and activation functions to initialize the model to be created. For example, integration system 105 may select initial hyper-parameters such as a number of layers and nodes, and determine whether the network will be fully or partially connected. In addition, in step 908 integration system 105 may determine the dimensionality of the network and/or determine stacks of receptive field networks. Moreover, in step 908 integration system 105 may also associate the model with one or more activation functions. For example, integration system 105 may associate the model with one or more sigmoidal functions. In step 910 integration system 105 may initialize weights for synapsis in the network.

In step 912, integration system 105 may input a validation dataset in the model. For example, integration system 105 may apply the input array based on features of training dataset of step 904 to calculate an estimated output and a cost function in step 914. In step 920, integration system 105 may determine whether the cost function is below a threshold of required accuracy, which may be specified by the user. If integration system 105 determines that the cost function is not below a threshold and the required accuracy has not being achieved, integration system 105 may continue to step 922 and modify model parameters. For example, when generating a neural network, in step 922 integration system 105 may determine a gradient to modify weights in synapses or modify the activation functions in the different nodes. However, if the cost function if below a threshold (step 920: Yes), integration system 105 may accept and communicate the model in step 924.

FIG. 10 is an exemplary graphical user interface (GUI) 1000 for accessing integrated data, in accordance with disclosed embodiments. In some embodiments, integration system 105 may generate instructions to display GUI 1000 in client devices 150.

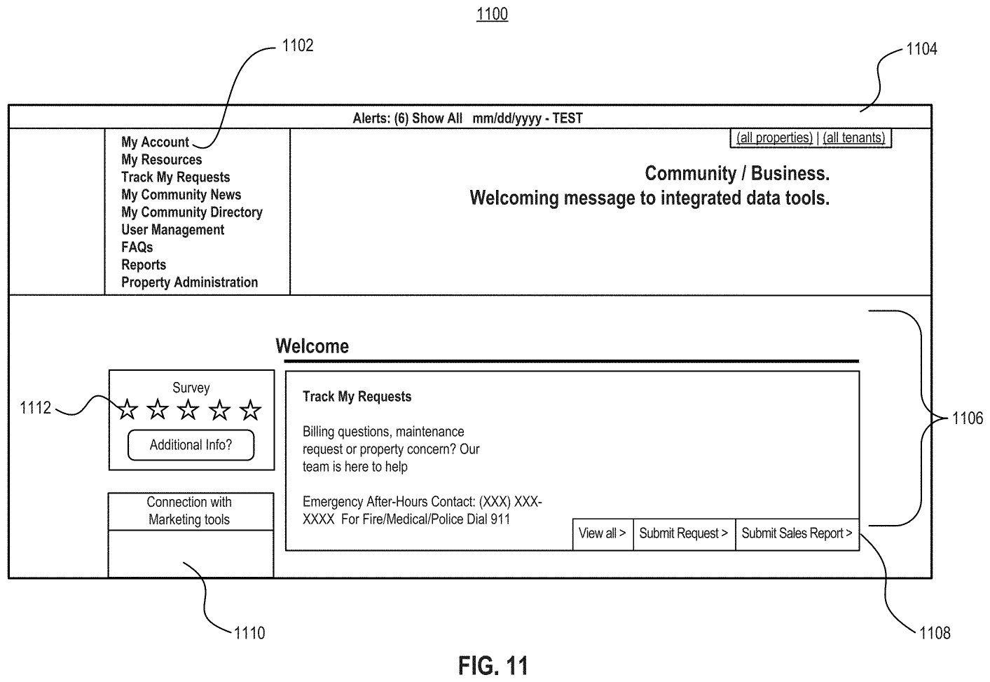

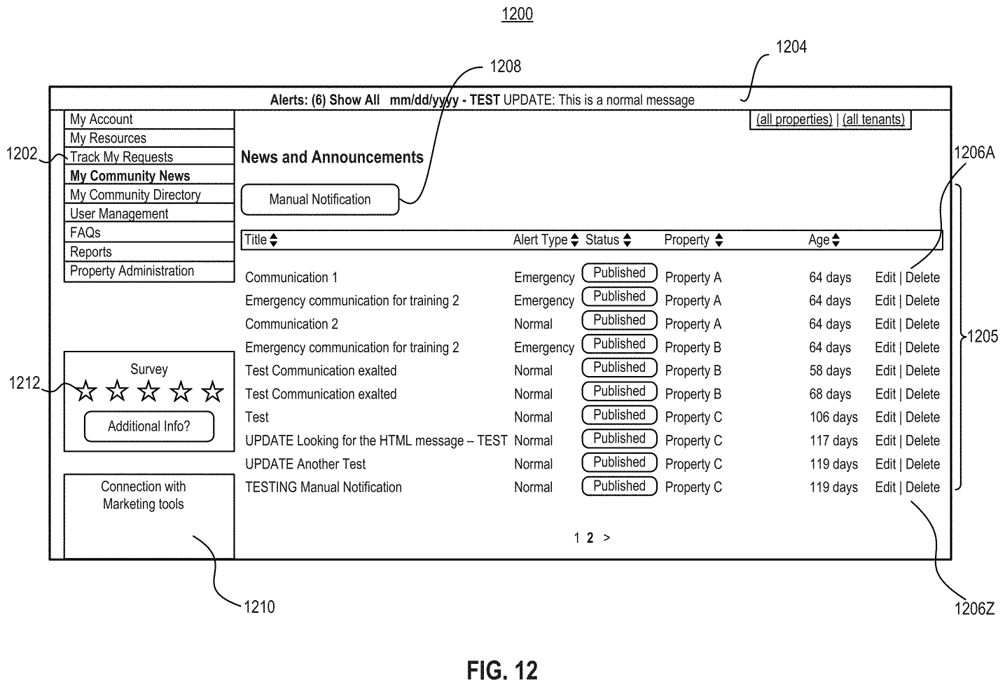

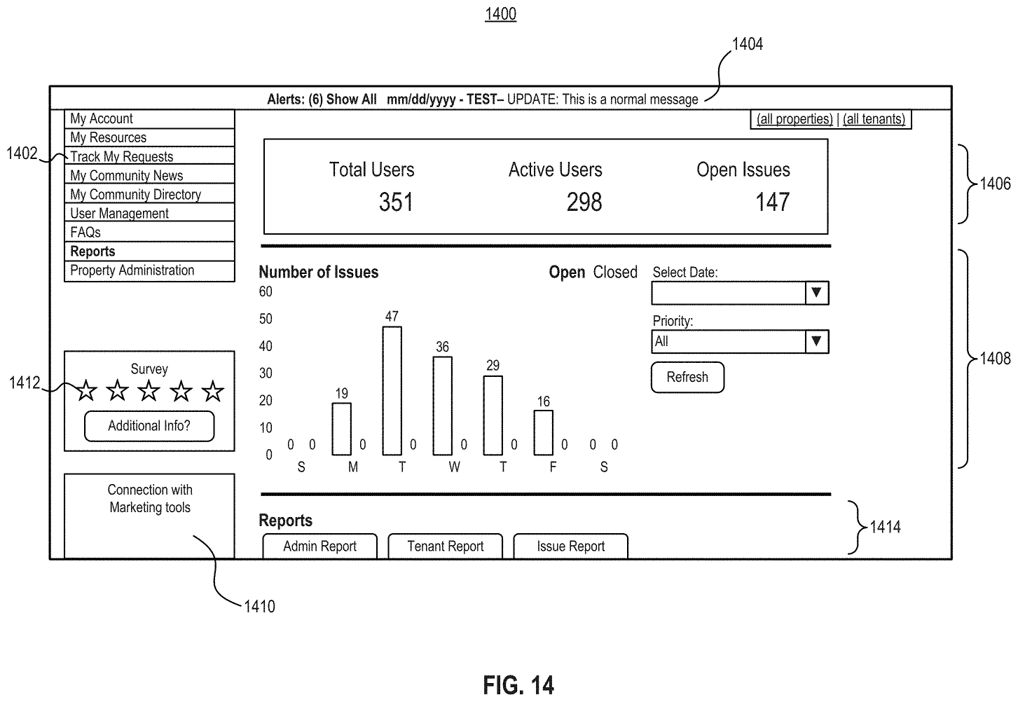

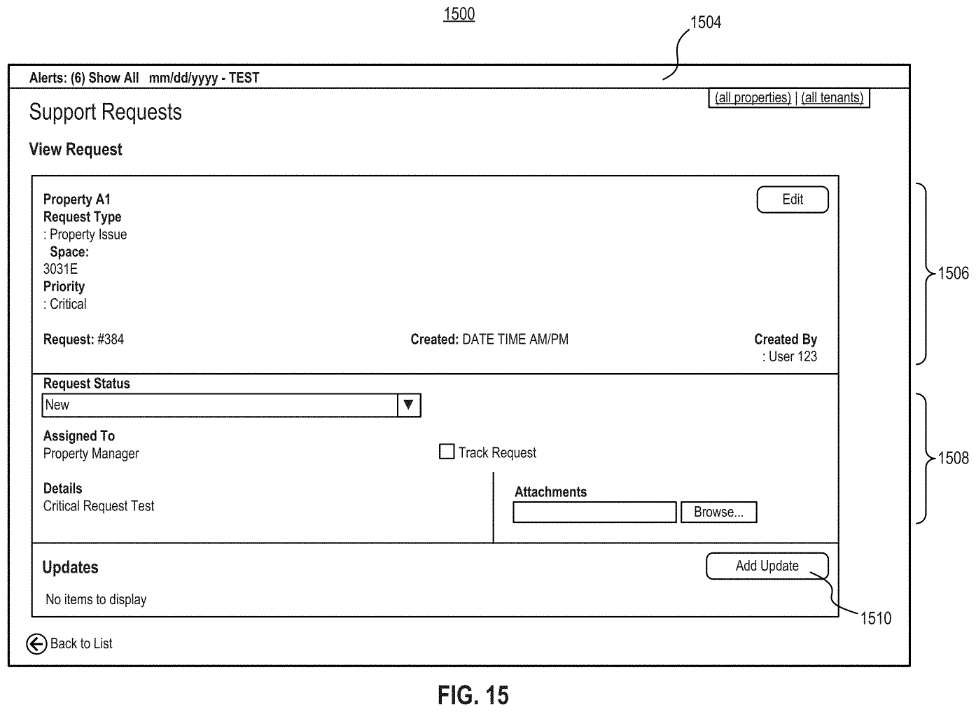

GUI 1000 may include a plurality of buttons that would allow a user to access additional GUIs, communication tools, or specific information. For example, GUI 1000 may include: an account button 1020 that when operated may open a window with account information, a track request button 1026 that when operated may show a user pending requests and their status (as further described in connection to FIG. 11), a news button 1026 that when operated may display windows with news information (as further described in connection with FIG. 12), a directory button 1028 that when operated may display a GUI with listing of properties (as further described in connection with FIG. 13), a user management button 1030 that when operated may display analysis of integrated data (as further described in connection with FIG. 14), a FAQ button 1032 that when operated may display a list of frequently asked questions, and a reports button 1034 that may display GUI's with input elements (as further described in connection with FIG. 15).

GUI 1000 may also include a search bar 1002 that may receive input from client devices 150. In addition, GUI 1000 may include a marketing tools button 1036, which may open dependent websites that allow interacting with marketing tools, like social media websites. In some embodiments, operating marketing tools button 1036 may automatically generate templates of advertising materials and/or engage with API configurator 120. Moreover, GUI 1000 may allow access to tools for tenant marketing documents including: flyer templates, sign templates, banner templates, press release templates, social media documents. Further, GUI 1000 may allow access to e-signing tools for document acceptance.

Moreover, GUI 1000 may include a series of panels with summarized information that may be based on integrated information compiled by integration systems 105. The panels may include a tracking panel 1004 that may show information about pending request. Tracking panel 1004 may also include sub-buttons 1006 with actions associated with tracking panel 1004. The panels may also include a news panel 1008, a resources panel 1012, and an account panel 1016. These panels may also include sub-buttons 1010, 1014, and 1018, respectively, with actions that are specific for each one of the panels.

For example, sub-buttons 1006 may be associated with hyper-links that take a user of GUI 1000 to different website views or input forms. In such embodiments, when a user selects the “view all” sub-button 1006 GUI 1000 may display a list of track requests by overlaying a window over the panels and/or displaying a new GUI that shows the requests. Further, when a user selects the “submit Req” sub-button 1006, GUI 1000 may display a form that allows a user of GUI 1000 to input information for a new request. In such embodiments, selecting the “submit Req” sub-button 1006 may open a pop-up window with a form to input information of a new request. Moreover, when a user selects the “submit sales” sub-button 1006, GUI 1000 may launch specific functions of integration system 105. For instance, selection of the “submit sales” sub-button 1006 may open communication tools further described in connection to FIG. 6.

Similarly, sub-buttons 1010, 1014, and 1018 may be hyperlinked to different websites, pop-up alternative views, display forms for input, or launch functions of integration system 105. For example, the “New Message” sub-button 1010 may launch communications functions of integration system 105 and/or display web forms in which the user may input information. In some embodiments, interacting with “New Message” sub-button 1010 may engage a Chatbot that may automatically reply answer queries or reply messages based on machine-learning parameters and/or using natural language processing. Further, the “create doc” sub-button 1014 may display secondary GUIs that allow users to upload documents and/or images.

Through GUI 1000 a user of system 100 may gain access to different services. Accordingly, GUI 1000 may be a landing page of a service platform that use integrated real estate data to facilitate communications, provide easily accessible status reports, generate alerts, and predict trends. The service platform may be a stand-alone product, or maybe an integrated product that is automatically synchronized with other elements of the system.

When working as a stand-alone product, the service platform accessible through GUI 1000 may permit access to ledgers associated with real estate properties. For example, through GUI 1000 users may gain the ability to store invoices online for a tenant and store documents in a document repository within the platform. In such embodiments, GUI 1000 may also allow that users with owner/operator roles to load invoices into the document repository by tenant. Further, GUI 1000 may allow users to capture disputed line items by invoice number, using a side-by-side viewer for a tenant to see the invoice and dispute form together. For example, one of the panels in GUI 1000 may show line item captures that may also be ticket routed to the identified role for invoice dispute resolution. Moreover, GUI 1000 may also provide a user the ability to enter explanations of commonly questioned charges.

When working as an integrated product, the service platform accessible through GUI 1000 may integrate with repositories of real estate data to display current information, such as ledgers. In some embodiments, the ledger data may be displayed as read-only and GUI 1000 may show how previous payments have been applied at the line-item level in one of the panels. Further GUI 1000 may display or flag recurring charges, include descriptions of charges for commonly misunderstood line items for the tenant, and may link to the online lease that may be provided for a tenant to review the line item descriptions in their lease.

In some embodiments, GUI 1000 may give access to windows displaying FAQs, general descriptions of the line items, and financial information like CAM (common area maintenance) charges, capital recovery charges, and management fees. Additionally, or alternatively, GUI 1000 may allow selection of line items in tenant ledger to be disputed by tenant. For example, GUI 1000 may give access to GUIs in which line items can be disputed individually by selecting dispute button and reference the line item number (as further described in connection to FIG. 12).

In certain embodiments, based on interactions with GUI 1000, integration system 105 may generate tickets that are routed to the identified role for invoice dispute resolution. For example, interactions within GUI 1000 that fall within criteria set by pre-determined business rules, may trigger a refund and note this on the ticket as well. In such embodiments, integration system 105 may provide tenant bill-back capability, allow communication with work order request systems, permit invoicing viewing, enable automated invoicing and display. GUI 1000 may also display banking information when resolving disputes and display wire transfer information for the financial institutions. Further, through GUI 1000 users may connect to the financial institutions and provide ACH payment capabilities.

FIG. 11 is an exemplary GUI 1100 for displaying requests, in accordance with disclosed embodiments. In some embodiments, integration system 105 may generate instructions to display GUI 1100 in client devices 150.

GUI 1100 may include an access menu 1102 with a plurality of buttons associated with hyperlinks. GUI 1100 may also include an alert bar 1104, a survey panel 1112, and a marketing panel 1110, GUI 1100 may also include a dynamic display box 1106 which may display specific information dictated by user role and user selections. Within the display box 1106, GUI 1100 may display one or more specific buttons 1108.

In some embodiments, GUI 1100 may be customizable depending on the roles of the viewing user. As described in connection with FIG. 7, integration system 105 may identify roles of users during an authentication process. Accordingly, GUI 1100 may be tailored for the type of user interacting with GUI 1100. For example. GUI 1100 may be adaptable depending on whether the user is a tenant, an admin, a property manager, or a property manager assistant.

When the user's role is tenant, GUI 1100 may be configured to be upload and read only. Further, GUI 1100 may allow access to specific sections of the platform provided by integration system 105. For example, GUI 1100 may allow access to tenant ledger sections, help desk sections, communications sections, document and data management sections, lease information sections, marketing materials sections, and/or tenant reporting sections. Under the tenant role, however, GUI 1100 may be configured to deny access to, for example, admin sections. Moreover, for tenant roles GUI 1100 may allow users to limit access to their “child” users.

In contrast, when the user's role is admin, GUI 1100 may be configured to include add, delete, retrieve, trash, and archive operations. In such scenarios, GUI 1100 may permit access allowed to admin sections, billing information sections, communications sections, document and data management sections, lease information sections, marketing materials sections, and owner/operator reporting sections.

When the user's role is property manager or property manager assistant, GUI 1100 may be configured to display read-only options. Under such role, GUI 1100 may be configured to allow access to billing information sections, communications sections, document and data management sections, lease information sections, marketing materials sections, and tenant reporting sections. GUI 1100 may also prevent access to certain sections of the platform under this role. For example, GUI 1100 may deny access to admin sections.

In some embodiments, integration system 105 may configure GUI 1100 to be accessible at the time a service platform launches. In such embodiments, GUI 1100 may retrieve code, content, and related assets that conform to the Web Content Accessibility Guidelines (WCAG) 2.0 AA Specification. For example, integration system 105 may configure GUI 1100 to present information to users in multiple ways. For example, integration system 105 may configure GUI 1100 with text Alternatives and provide text alternatives for any non-text content so that it can be changed into other forms people need, such as large print, braille, speech, symbols or simpler language. Further, integration system 105 may configure GUI 1100 to include time-based media and have adaptability capabilities to create content that can be presented in different ways (for example simpler layout) without losing information or structure. Moreover, integration system 105 may configure GUI 1100 to make it easier for users to see and hear content including separating foreground from background.

Although not shown, in some embodiments, GUI 1100 may also include navigation and accessibility components. For example, GUI 1100 may display a keyboard for accessibility, employ timers to provide users enough time to read and use content, and provide ways to help users navigate, find content, and determine the current webpage. Further, GUI 1100 may be configured to show understandable icons that appear and operate in predictable ways, and include I/O devices with input assistance to help users avoid and correct mistakes.

In addition, in some embodiments, integration system 105 may configure GUI 1100 to display content robust enough that it can be interpreted reliably by a wide variety of user agents, including assistive technologies. Further, integration system 105 may generate GUI 1100 to maximize compatibility with current and future user agents, including assistive technologies. Accordingly, GUI 1100 may be configured to function on the latest version of the internet browsers.

Similar characteristics may be applied to other GUIs described in connection to FIGS. 10 and 12-16. For example, GUI 1000 (FIG. 10) may share one or more of the above-described characteristics for GUI 1100.

FIG. 12 is an exemplary GUI 1200 for displaying notifications, in accordance with disclosed embodiments. In some embodiments, integration system 105 may generate instructions to display GUI 1200 in client devices 150.

GUI 1200 may include an access menu 1202 with a plurality of buttons associated with hyperlinks. GUI 1200 may also include an alert bar 1204, a survey panel 1212, and a marketing panel 1210. GUI 1200 may also include a body 1205 which may list communications 1206A-1206Z. As shown in FIG. 12, each of the communications 1206 may show a title, alert type, status, property, age, and delete edit buttons. Moreover, GUI 1200 may include a manual notification 1208, which may allow users to manually create notifications. GUI 1200 may be displayed when integration system 105 works as a stand alone system but also when it works integrated with other elements of system 100, such as online resources 140 (FIG. 1).

Integration system 105 may provide help desk features through GUI 1200. For example, GUI 1200 may be configured to provide an emergency contact list for owner/operator associates and tenants. With GUI 1200 tenants may have the ability to view other tenants' contact information, update emergency contact info, provide the ability to submit tickets, and select the issue types from a predefined list. Further, through GUI 1200 tenants may enter a description of the issue and upload files with the issue. Although not shown in FIG. 12, GUI 1200 may have input icons that allow updating images, PDFs, word documents, and excel files.

Further, GUI 1200 may allow tenants to designate a ticket as public (related to a common area) or private (specific to the tenant's space). In such embodiments, a ticket designated as public by a tenant may be approved as public by an owner/operator role before being published for tenants to view. Instead, a tenant's private ticket may be closed and the tenant notified of the public ticket.

GUI 1200 may also provide sales collection reports that may be accepted via form submission with optional attachment. In such embodiments, GUI 1200 may notify at least one owner/operator role of a new ticket submission. Further GUI 1200 may include documentation to allow any owner/operator role to attempt to resolve an issue and log interactions needed between owner/operator role(s) and tenant to resolve an issue.

In some embodiments, GUI 1200 may provide a list of tickets for at least one owner/operator role. In such embodiments, the list may be sortable and filterable by ticket status, ticket age, tenant, public or private category and property. GUI 1200 may also provide a summary of submitted tickets on the tenant's dashboard showing any open tickets they have submitted, and any “public” category tickets submitted by other tenants. Further, GUI 1200 may create an escalation notice to an owner/operator supervisor role if there is no response to a tenant after a configurable time period (i.e., an exceed age).

Moreover, GUI 1200 may automatically send a rate/review request when a ticket is closed. Using survey panel 1212, GUI 1200 may include a rating/review s for a ticket and/or a vendor. A tenant may complete a rating/review via an email submission or directly in the portal and a notification may be sent to an owner/operator supervisor role for any rating less than a 3 out of 5. In some embodiments, integration system 105 may moderate ratings prior to being published within the platform using, for example, the machine learning categorizations described above.

Furthermore, GUI 1200 may display reviews by owner/operator roles but not visible to tenants. GUI 1200 may also provide the ability for at least one owner/operator role to review a report of ratings/reviews by property, vendor owner/operator role, or issue type. Thus, through GUI 1200 integration system 105 may provide the ability to communicate directly with the proper owner/operator department for a given question/issue via email, phone number with click-to-call for emergency requests, and click to request a call back from the appropriate owner/operator role based on the issue attempting to be resolved.

FIG. 13 is an exemplary GUI 1300 for displaying a property directory, in accordance with disclosed embodiments. In some embodiments, integration system 105 may generate instructions to display GUI 1300 in client devices 150.

GUI 1300 may include an access menu 1302 with a plurality of buttons associated with hyperlinks. GUI 1300 may also include an alert bar 1304, a survey panel 1312, and a marketing panel 1310. GUI 1300 may also include a body 1306 which may list real estate information, such as real estate properties. As shown in FIG. 12, GUI 1300 may also display an emergency contact link 1308.

In some embodiments, integration system 105 may use GUI 1300 for general communication features with client devices 150 and/or other elements of system 100 (FIG. 1). For example, through GUI 1300, integration system 105 may allow tenants to set default notification preferences for each one of the listed properties, including preference for email and/or click-to-call back. Further, GUI 1300 may be configured to use the default communication method selected by tenant and allow tenants to opt-out of communication channels.

As shown in FIG. 13, GUI 1300 may also provide emergency communications and GUI 1300 may be configured to not allow users to opt out of emergency communications. Moreover, GUI 1300 may provide selections for users to send transactional emails—based on user interactions—and scheduled “bulk” messages. In some embodiments, GUI 1300 communications may include the capacity to be multilingual, including Right-to-Left languages. In such embodiments, integration system 105 may be configured to provide offline translations prior to uploading documents or requests. Moreover, GUI 1300 may include an internal search tool supporting common questions and free form search entries.

In some embodiments, GUI 1300 may include pre-set communications such as “Report a billing error,” “Pay my rent,” “Report a parking lot issue,” “Request lighting repair,” “Request service,” and/or “HVAC repair.” Alternatively, or additionally, GUI 1300 may grant access to a FAQ section for information on using the GUIs.

Moreover, GUI 1300 may be configured in multiple languages and automated translation tools may be pre-programmed in GUI 1300. For example, GUI 1300 may be configured to display messages in different languages based on preferences or user locations. Alternatively, or additionally, GUI 1300 may include options for automated translation.

In some embodiments, GUI 1300 may also provide communication channels for SMS/Text and include SMS opt-outs may be managed via the SMS system and synced to the platform.

FIG. 14 is an exemplary GUI 1400 for displaying real estate data visualization, in accordance with disclosed embodiments. In some embodiments, integration system 105 may generate instructions to display GUI 1400 in client devices 150.

GUI 1400 may include an access menu 1402, an alert bar 1404, a survey panel 1412, and a marketing panel 1410. GUI 1400 may also include a top banner 1406, a bottom banner 1414, and a body 1408. Body 1408 may include dynamic visualizations of real estate data. In some embodiments, the data displayed in body 1408 may be normalized and filter through operations described in connection with FIGS. 6-8. Further, body 1408 in GUI 1400 may also include filtering tools to manipulate visualizations by specifying, for example, dates and property types. Moreover, GUI 1400 may also display summarized analytics in top banner 1406 and buttons to access analytics reports in bottom banner 1414.

Through GUI 1400, integration system 105 may provide alert system features. For example, GUI 1400 may include a notification center to display non-emergency messages and alerts. GUI 1400 may be configured to provide options to sign up for automated alerts via preferred communication method. Alerts may include upcoming renewal dates, AC maintenance dates. Certificate of Insurance (COI) updates due, invoice timing changes, and/or sales collection reports due. Further, integration system 105 may configure the lead time of each message or alert displayed in GUI 1400. In such embodiments, alerts in GUI 1400 may be configurable to include a calendar for choosing a specific date of the alert, setting recurrence of the alert, and adding additional contacts to the alert. Moreover, through GUI 1400 tenant may be able to see a list of alerts to which they have subscribed.

Integration system 105 may also provide reporting features for users through GUI 1400. For example, GUI 1400 may provide an owner/operator-specific reports dashboard that includes ratings/review summaries. Further, GUI 1400 may include a help desk ticket summary, a summary of sales collection reports submitted, a top-visited pages summary, and a time-on-platform summary. In such embodiments, GUI 1400 may be tailored for tenant-types and include reports sortable and/or filterable by property, tenant ID, a date range, and the report-specific fields. GUI 1400 may also provide a tenant-specific reports dashboard and include a “Report an Issue” listed at the top as the default on mobile format. Further, GUI 1400 may display a dashboard including a ratings/review summary, a help desk ticket summary, and public tickets. In some embodiments, the dashboard may also include a summary of sales collection reports submitted, top-visited pages summary, sortable and/or filterable records by property, tenant, a date range, and the report-specific fields. Additionally, or alternatively, GUI 1400 may provide a national tenants report summarizing stores they have within owner/operator properties and include billing summary by store, issue summary by store, and/or lease/renewal dates by store.

In some embodiments, GUI 1400 may also display analytics results. For example, integration system 105 may track metrics like page visits, time on page, total time per session, and button/link clicks within pages that contain multiple user action options. GUI 1400 may be configured to display these metrics in, for example, body 1408.

FIG. 15 is an exemplary GUI 1500 for displaying and collecting property information, in accordance with disclosed embodiments. In some embodiments, integration system 105 may generate instructions to display GUI 1500 in client devices 150.

GUI 1500 may include an alert bar 1504, a property information section 1506, an input section 1508, and an update button 1510. In some embodiments, GUI 1500 may be used for document and data management. For example, GUI 1500 may be used to receive information from client devices 150. As previously described in connection to FIG. 8, this captured information may be filtered and normalized to generate data structures that facilitate coordinating real estate operations.

In some embodiments, GUI 1500 may be configurable for the upload of documents. GUI 1500 may enable users to bulk upload documents and/or associate a document with a tenant or property. Moreover, GUI 1500 may support multiple document types include leases, periodic tenant agreements and amendments, exhibits, guaranty, addendums, related documents (e.g., acceptance or possession of space, collateral assignment, commencement date agreement, consent letter, option exercise, termination settlement, tenant contact, assignments, amendments), certificates of insurance, correspondence (consent letters, request for tenant to remedy, newsletters, termination—settlement, tenant contact info change, documentation of sales). In some embodiments, the classification may be determined by machine learning algorithms trained to automatically classify documents based on their content, form, or metadata information.

GUI 1500 may also allow users to store and retrieve documents and grant accessibility permissions. Further, through GUI 1500 integration system 105 may provide a mechanism for collection of data from tenants.

FIG. 16 is an exemplary GUI 1600 for accessing integrated data via mobile devices, in accordance with disclosed embodiments. In some embodiments, integration system 105 may generate instructions to display GUI 1600 in client devices 150.

GUI 1600 may include an image search icon 1602 and a voice search icon 1604. Moreover, GUI 1600 may include an emergency button 1608, a tickets button 1610, and a direct communication button 1606. Moreover, GUI 1600 may include a ticket list 1614 with multiple items, each being associated with one or more escalation buttons 1612. Users may access integration system 105 through GUI 1600 and request information and/or upload documents.

FIGS. 17-21 show exemplary graphical representations of data models for different functions that may be performed by integration system 105. As represented in FIGS. 17-21, information stored by integration system 105 may be stored in multiple interactive objects. Each one of the objects may have pre-programmed connections and interactions and be defined by variables storing information such as when the object was created, object identification, record of modification, and users.

FIG. 17 is an exemplary graphical representation of a property data model 1700, in accordance with disclosed embodiments. Property data model 1700 includes a plurality of objects configured with pre-programmed connections and/or interactions. Objects in property data model 1700 may include a space object 1702, a building object 1704, a property object 1706, and a routing object 1708 that is coupled to a bank object 1720. Further, objects in data model 1700 may also include an occupant object 1710, an occupant address object 1712, and address object 1714, and a building address 1716. Moreover, property data model 1700 may include a user property object 1718. Objects 1702-1718 may provide integration system 105 information about the user and facilitate or automate interactions. For example, objects 1702-1718 may store information like building ID, square footage, or bank information in objects 1702-1718 to facilitate or automate future interactions with users.

Moreover, property data model 1700 may also include objects directed to facilitate communications. For example, property data model 1700 may include a master occupant object 1722, a tenant address object 1724, a country object 1726 and a country subdivision object 1738. Moreover, property data model 1700 may include a user content management system (CMS) objects 1728 and 1742. Further, property data model 1700 may include a tenant contact object 1744, a general contact object 1746, and a contact type 1748. These object may store information that enable integration system 105 to automate communication processes.

As shown in FIG. 17, objects of property data model 1700 may have different connection and be preprogrammed with different interactions. For example, property contact object 1734 may communicate with contact type object 1748 while building address object 1716 may be coupled and interact with address type object.

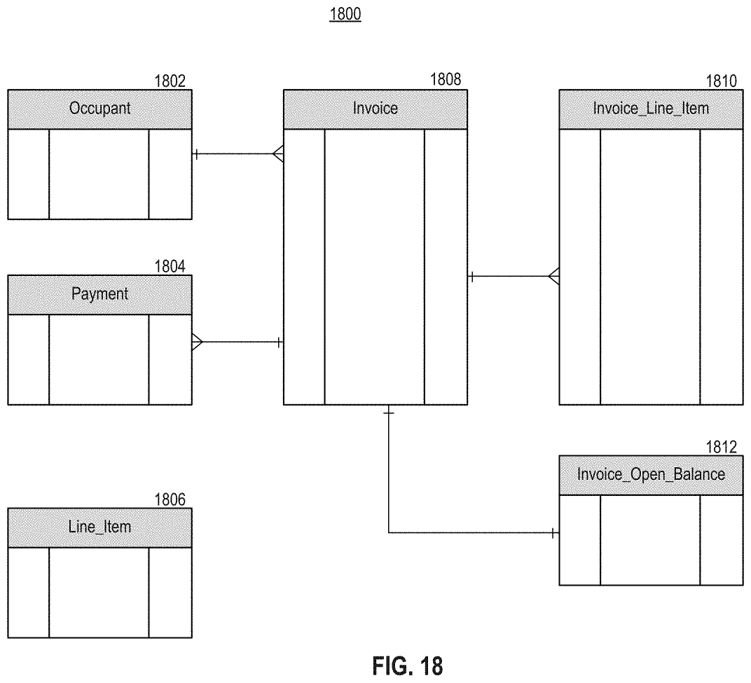

FIG. 18 is an exemplary graphical representation of a ledger data model 1800, in accordance with disclosed embodiments. Ledger data model 1800 includes object that represent information for maintaining ledgers of tenant accounts. Ledger data model 1800 may include an occupant object 1802, a payment object 1804, and a line item 1806. Information stored in objects 1802-1806 may include transaction dates, amounts, transaction explanations and descriptions, among other information related with a tenant.

In addition, ledger data model 1800 may include different invoice objects. For example, ledger data model 1800 may include a general invoice object 1808, an invoice line item object 1810, and an invoice open balance object 1812. Each one of these invoice objects 1808-1812 may information such as open amount, description, and/or payments.

As shown in FIG. 18, objects in ledger data model 1800 may share different connections. For example, occupant object 1802 may be configured to receive information from general invoice object 1808.

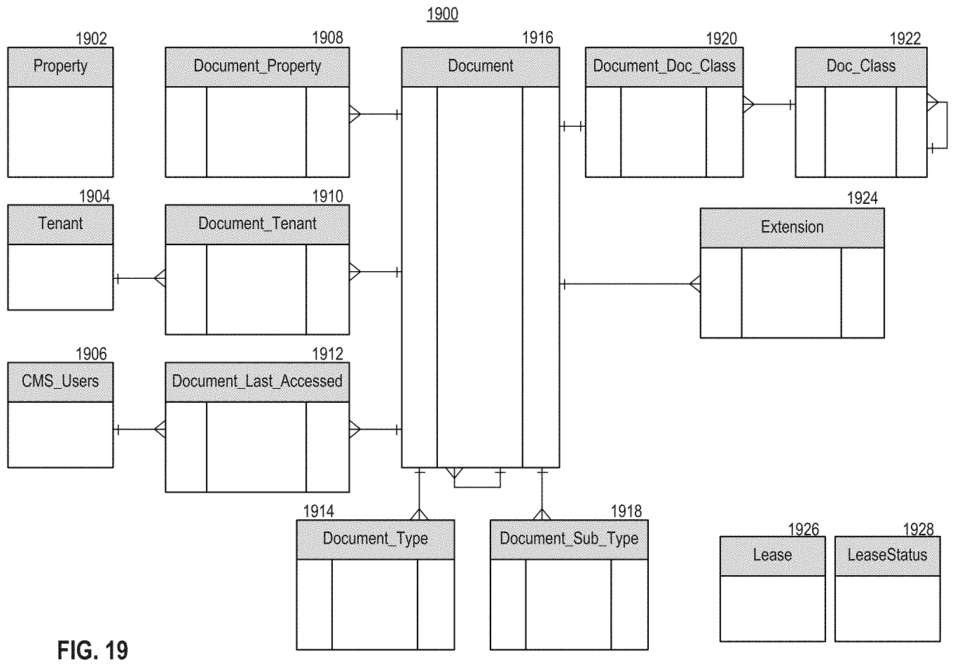

FIG. 19 is an exemplary graphical representation of a document data model 1900, in accordance with disclosed embodiments. Document data model 1900 may be employed when a user uploads a new document to be classified and/or categorized by integration system 105, Document data model 1900 may include a property object 1902, a tenant object 1904, and a CMS user object 1906. These objects may be coupled to one or more of document property object 1908, document tenant object 1910, document last access object 1912, and document type object 1914. In such embodiments, objects 1908-1914 may store information such as identification tags, access dates, and document metadata that allows the classification or categorization of documents.

Further, document data model 1900 may include objects that further define the document. For example, document data model 1900 may include a document subtype object 1918, a document class object 1922, and a document sub class object 1920. Further, document data model 1900 may include an extension object 1924, a lease object 1926, and a lease status object 1928.

As shown in FIG. 19, objects of document data model 1900 may have different connections and relations. For example, extension object 1924 may provide information to document object 1916. Similarly, document last accessed object 1912 may provide information to CMS user object 1906.

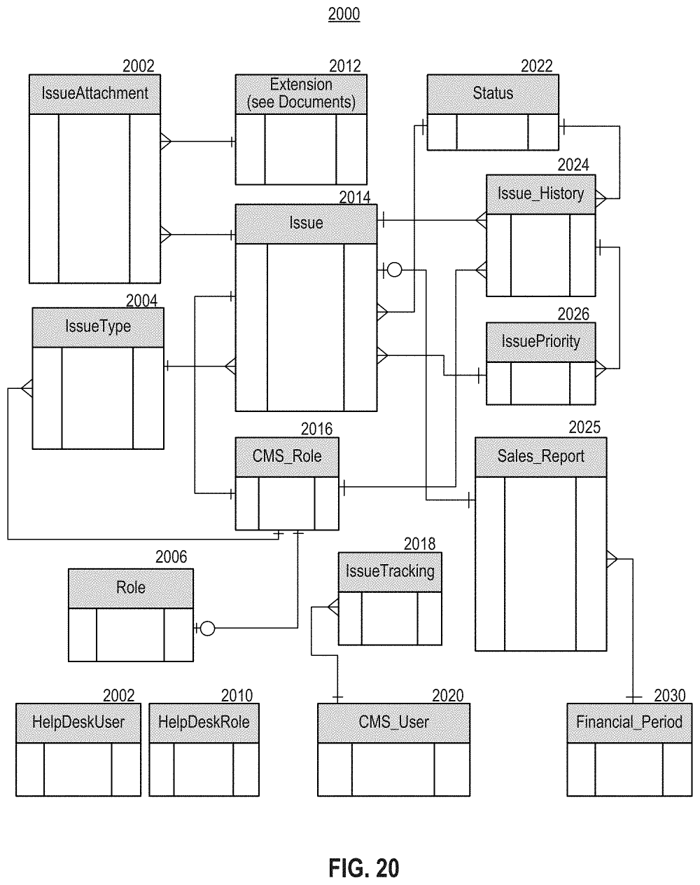

FIG. 20 is an exemplary graphical representation of a help desk data model 2000, in accordance with disclosed embodiments. Help desk data model 1900 may be employed when a user uploads a new document to be classified and/or categorized by integration system 105.

Help desk data model 2000 may include an issue attachment object 2002, an issue type object 2004, a role object 2006, a help desk user 2008, and a help desk role 2010. Further, help desk data model 2000 may include an extension object 2012, which may be equivalent to extension object 1924 (FIG. 19), an issue object 2014, an issue tracking object 2018, a CMS role object 2016, and a CMS user object 2020. Objects 2000-2020 may include information of queries from client devices including issue descriptions, ticket numbers, document data, due dates, among others.

Help desk data model 2000 may also include a status object 2022, an issue history 2024, an issue priority 2024, sales report 2028, and a financial period 2030. These elements may allow integration system 105 to keep track of queries and user interactions and pre-program workflows for information exchanges.

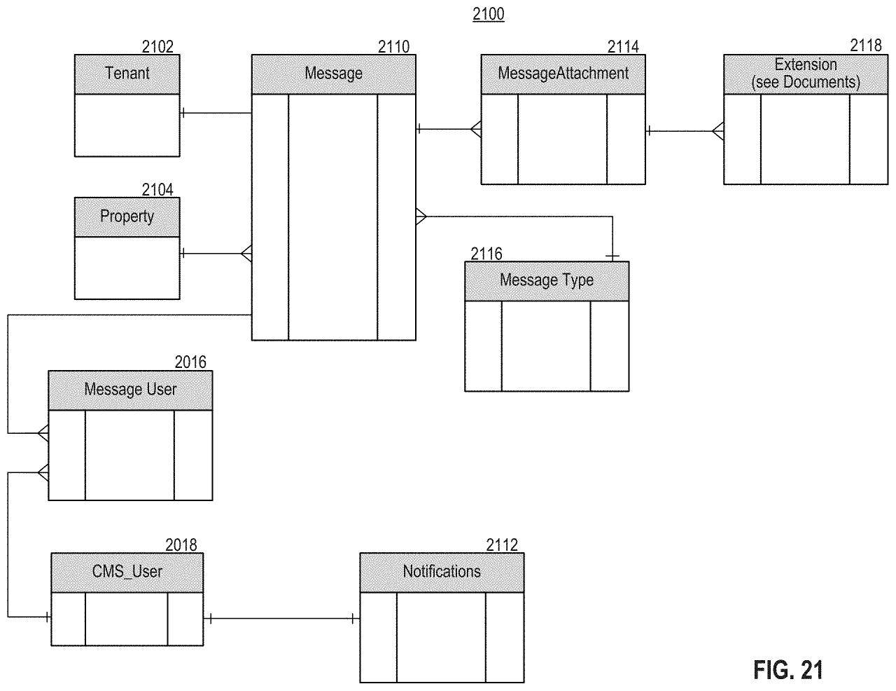

FIG. 21 is an exemplary graphical representation of a communications data model 2100, in accordance with disclosed embodiments. Communications data model 2100 may enable communications between integration system 105 and users of integration system 105. For example, communications data model 2100 may guide be employed when responding to user queries or when a user sends a message using, for example, GUI 1000 (FIG. 10).

Communications data model 2100 may include a tenant object 2102, a property object 2104, a message user object 2106, and a CMS user 2108. These elements may be coupled to one or more of a message object 2110, a notifications object 2112. Further, message object 2110 may be coupled with a message attachment object 2114 and a message type object 2116. In turn, message attachment object 2114 may be coupled to an extension object 2118.

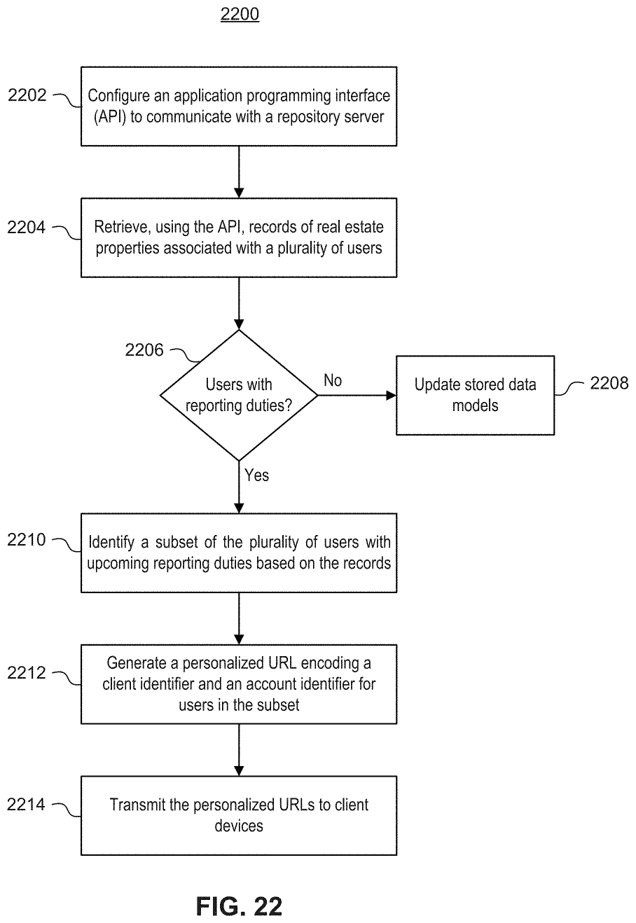

FIG. 22 is a flow chart illustrating an exemplary process 2200 for generating personalized uniform resource locators (URLs), in accordance with disclosed embodiments. In some embodiments, process 2200 may be executed by integration system 105. For example, DNAA 110 may perform steps in process 2200. In other embodiments, however, process 2200 may be performed by client devices 150. Further, in some embodiments process 2200 may be performed by multiple elements of system 100. The description of process 2200 below illustrates an embodiment in which integration system 105 performs steps of process 2200, but other embodiments are possible.

In step 2202, integration system 105 may configure an application programming interface (API) to communicate with a repository server. For example, integration system 105 may prepare API keys for calling functions or operations from a repository server. Further, integration system 105 may connect to any REST, GraphQL, or SOAP API. For example, integration system 105 may prepare requests to any HTTP, GraphQL, or SOAP API with Retool. In some embodiments, configuring the API in step 2202 may include constructing JSON object using key-value interfaces and/or uploading binary files. The API configuration may allow integration system 105 to access data in the repository server, which may store information from real estate properties through a data model, which (as discussed in connection with FIGS. 17-21) include a plurality of objects configured with pre-programmed connections, the objects including an occupant object, an address object, a building object, and a bank object, wherein the building object stores a building ID.

In step 2204, integration system 105 may retrieve, using the API, records of real estate properties associated with a plurality of users. For example, in step 2202 integration system 105 may connect to repository server that stores information about users. In such embodiments, integration system 105 may fetch user data stored in the repository server through API calls following a REST architecture style. Information fetched through the API may be a CSV file, a JSON, or a plain XML, among others. Further, integration system 105 may access the repository server using administrator credentials and access information through HTTP requests such as:
https://[Domain]/APIServices/api.asp?$api=[APIName]
Host: [WebDomain]

In step 2206, integration system 105 may determine whether users retrieved through the API have reporting duties. For example, integration system 105 may determine whether at least one of the users in a CSV file retrieved through the API has periodic reporting duties. In some embodiments, the reporting duties may include periodic sales reports. This is only an example, however, an in other embodiments the reporting duties may include number of customers, number of visits, disbursements, or any other type of action related to real property management. If integration system 105 determines that users retrieved through the API do not have reporting duties (step 2206: No), integration system 105 continues to step 2208 and updates stored data models as discussed in connection with FIGS. 17-21. For example, integration system 105 may create new entries with POST HTTP instructions and/or merge existing entries through a PUT HTTP instruction. But if integration system 105 determines that users retrieved through the API have reporting duties (step 2206: Yes), integration system 105 continues to step 2210.

In step 2210, integration system 105 may identify a subset of the users with upcoming reporting duties based on the records. For example, integration system 105 may filter the users to identify a subset of users with reporting duties. The filtering may be performed based. on a time window. For example, in some embodiments integration system 105 may identify a subset of users with reporting duties within 10 days. Other timeframes are also possible, however, and integration system 105 may filter users with reporting duties within a week, two weeks, or a month. Further, integration system 105 may also identify users with missing reporting periods in step 2210. For example, integration system 105 may identify users with a missing status associated with monthly sales reports.

In step 2212, integration system 105 may generate a personalized URL encoding a client identifier and an account identifier for users in the subset. For example, integration system 105 may encode a URL with client ID and/or account ID identifiers for users in the subset of users with reporting duties. The encoded URL may also include pointers to the specific reporting period. In some embodiments, encoding the URL includes employing JavaScript, or ASP functions to URL encode a string. For example, integration system 105 may use a PHP has the rawurlencode( ) function or an ASP Server.URLEncode( ) function. Further, integration system may use a JS encodeURIComponent( ) function. Moreover, in some embodiments, the personalized URL of step 2212 may be configured for redirection by a redirect server. For example, integration system 105 may generate a personalized URL which triggers a redirection to a landing page by a redirect server in integration system 105. Such landing page may be specific for one of the users identified in step 2210. Further, in certain embodiments the personalized URL may embed cookies to track a user session. For example, the personalized URL may set cookies for a specific user session, such as by specifying Set-Cookie: session=your_session; SameSite=None; Secure.

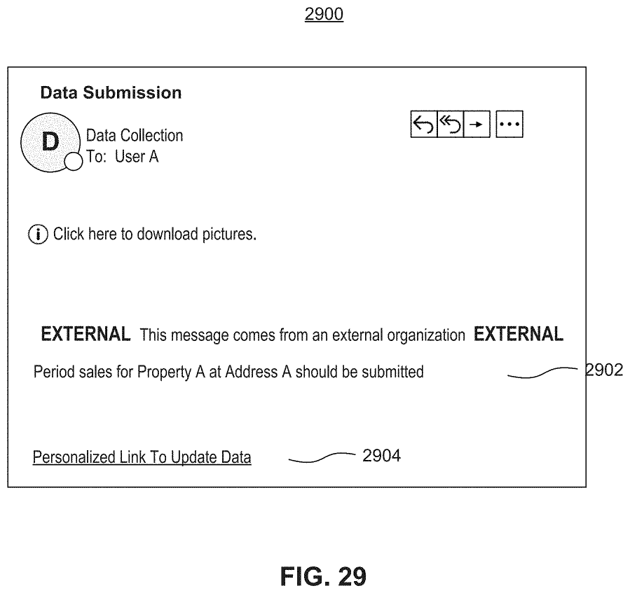

In step 2214, integration system 105 may transmit the personalized URLs to client devices 150. For example, integration system 105 may identify electronic addresses associated to users with reporting duties and transmit electronic notifications to those addresses. As further described in connection with FIG. 29, the electronic notification may include the personalized URL so that a user can quickly input reporting data. Alternatively, or additionally, integration system 105 may transmit the personalized URL via pop-up notifications and/or SMS. For example, integration system 105 may provide the personalized URL and user address information to Apple Push Notification service and/or Google Cloud Messaging to transmit the personalized URLs to mobile devices. Additionally, or alternatively, transmitting the personalized URLs may include generating one or more electronic notifications including a hyperlink to the personalized URL and transmitting the electronic notifications to electronic addresses associated with the users.

The generation of personalized URLs may resolve problems of collection of data from users in a network. Collecting information from users can be cumbersome when there is a plurality of platforms or multiple client devices. Users may input data in different formats and/or at different times. Further, users may neglect to report information or enter incorrect information that is not usable for aggregation. The disclosed systems, and particularly process 2200, improve the technical field of data collection, normalization, and analysis, by generating personalized URLs that allow simple, uniform, and efficient collection of user data. For example, by providing electronic notifications with personalized URLs, integration system 105 facilitates the collection of data from users by guiding users directly to personalized landing pages.

The use of personalized URLs also improves the technical field of data collection in a distributed network. In particular, the disclosed process 2200 may reduce network congestion in servers of integration system 105 by directly taking users to specific landing pages. Instead, of requiring users to navigate through multiple sites and/or collect information from multiple objects, the disclosed systems may minimize congestion and time in the network by generating the personalized URLs with encoded information that allows servers to efficiently direct requests. Thus, disclosed embodiments described in connection with FIG. 22 provide a distributed network architecture for collection of user data operating in an unconventional fashion to reduce network congestion while generating networking accounting data records.

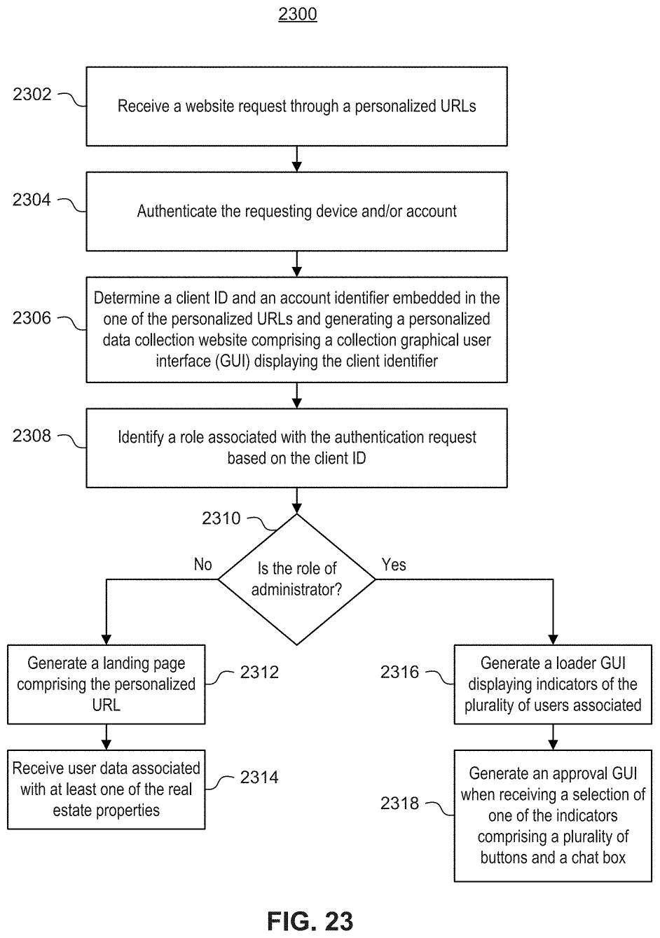

FIG. 23 is a flow chart illustrating an exemplary process 2300 for authenticating users and displaying graphical user interfaces, in accordance with disclosed embodiments. In some embodiments, process 2300 may be executed by integration system 105. For example, DNAA 110 may perform steps in process 2300. In other embodiments, however, process 2300 may be performed by client devices 150. Further, in some embodiments process 2300 may be performed by multiple elements of system 100. The description of process 2300 below illustrates an embodiment in which integration system 105 performs steps of process 2300, but other embodiments are possible.

In step 2302, integration system 105 may receive a website request through a personalized URL. For example, integration system 105 may receive a website request from a client device directed to the personalized URL. The website request may include client information such as a client or an account ID. Moreover, in some embodiments, the website request may be received through a redirect server. In step 2304, integration system 105 may authenticate the requesting device and/or account. As further described in connection with FIG. 7, steps 702-706, integration system 105 may authenticate a user associated with the website request through an SSO system.

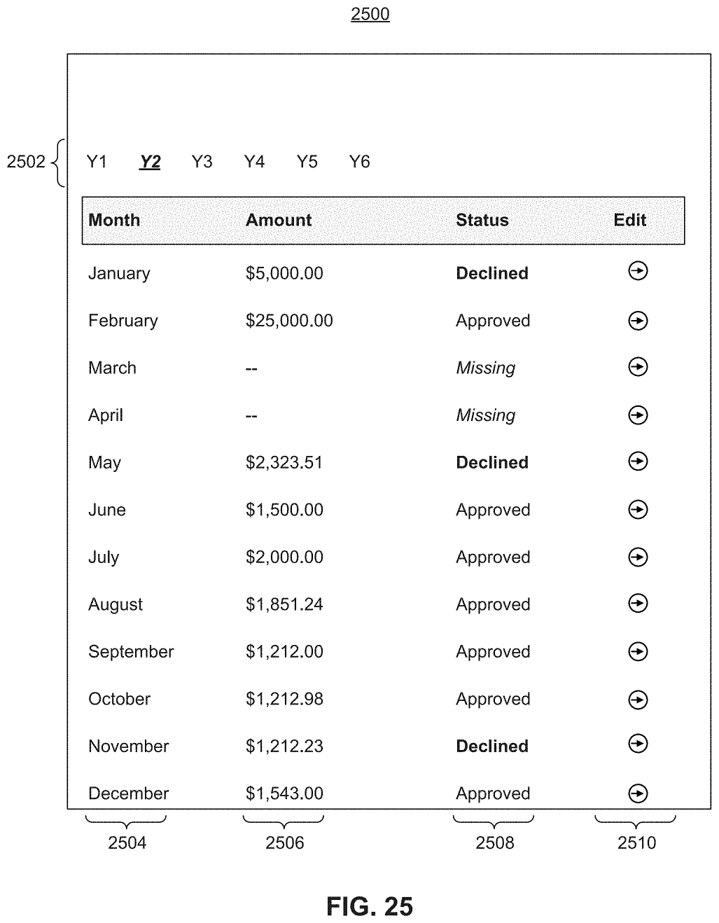

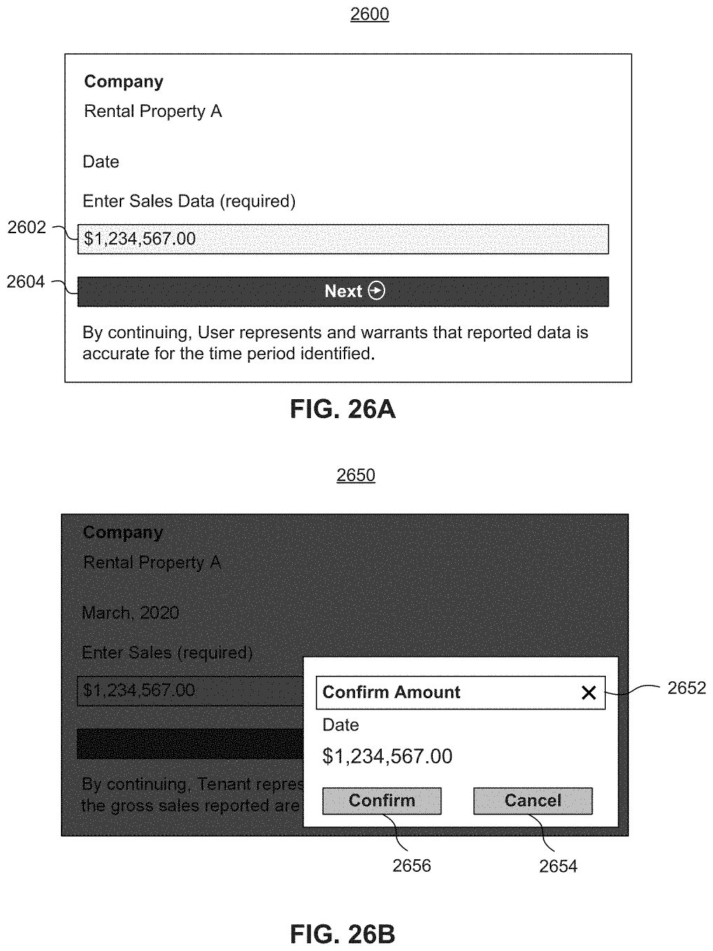

In step 2306, integration system 105 may determine a client ID and an account identifier embedded in the one of the personalized URLs and generate a personalized data collection website comprising a collection graphical user interface (GUI) displaying the client identifier. For example, based on the information encoded in the personalized URL (such as client ID and/or session cookies), integration system 105 may generate and display a collection website that allows users to input reporting data. In some embodiments, integration system 105 may direct users with the personalized URL to webpages like the ones described in connection with FIGS. 25, 26A, or 26B.

In step 2308, integration system 105 may identify a role associated with the authentication request based on the client ID. For example, as described in connection with FIG. 7, integration system 105 may identify a role associated with the request. Based on the credentials and/or the client ID, integration system 105 may correlate the website request with a. user role.

In step 2310, integration system 105 may determine whether the role associated with the client ID is an administrator or other type of user—such as a tenant. If integration system 105 determines the role associated with the client ID is not administrator (step 2310: No), integration system 105 continues to step 2312 and generate a landing page for information collection. For example, integration system 105 may be configured to identify a role associated with the authentication request based on the client ID and, in response to determining the role to be a tenant, generating a landing page comprising the personalized URL. And in step 2314, integration system 105 may receive user data associated with at least one of the real estate properties. For example, a user may input data in a collection GUI (see FIG. 26B) and the collected data may be captured by integration system 105 for aggregation and/or analysis. In such embodiments, integration system 105 may receive user data associated with at least one of the real estate properties that is in a repository server accessed through the API setup in process 2200. Further, integration system 105 may also update the repository server with the user data through an API call, such as a POST or PUT methods.

In some embodiments, step 2314 may also include the collection of user documents. For example, a collection GUI may include options for receiving documents from users and display an upload icon. In such embodiments, integration system 105 may be configured to receive one or more user files from the client device, associate the user files with one of the users, and identify a data model associated with the document. Moreover, as further described in connection with FIG. 6, integration system 105 may generate a searchable file based on the documents and update the repository server with the searchable file through an API call that transmits the user file and/or metadata extracted from the file. In such embodiments, after updating the repository server with the searchable file, integration system 105 may be configured to transmit a request to a vendor server, the request specifying a service request based on trends identified from the searchable file. For instance, based on keywords or metadata tags identified in files, integration system 105 may automatically prepare messages and/or connections with a roofing service vendor, a marketing vendor, among others, as discussed in connection with FIG. 8.

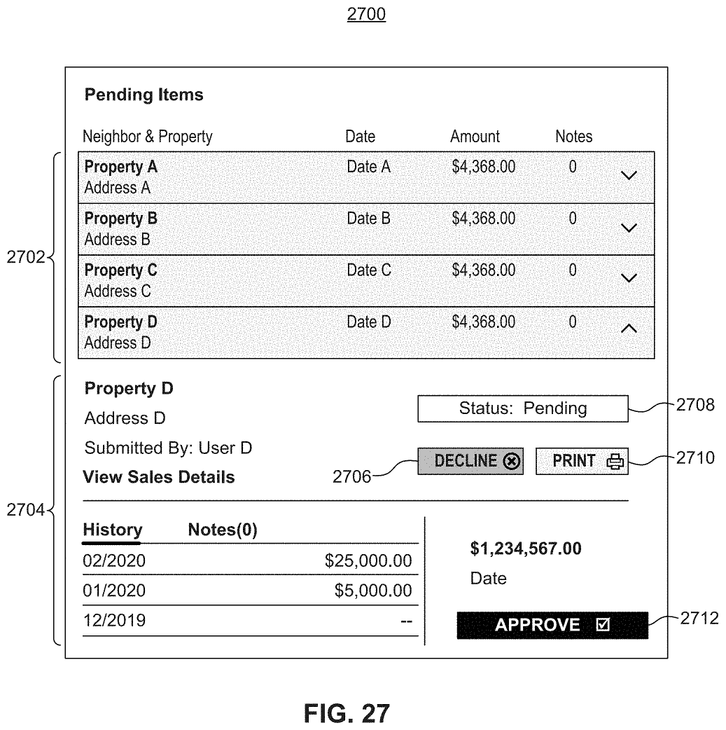

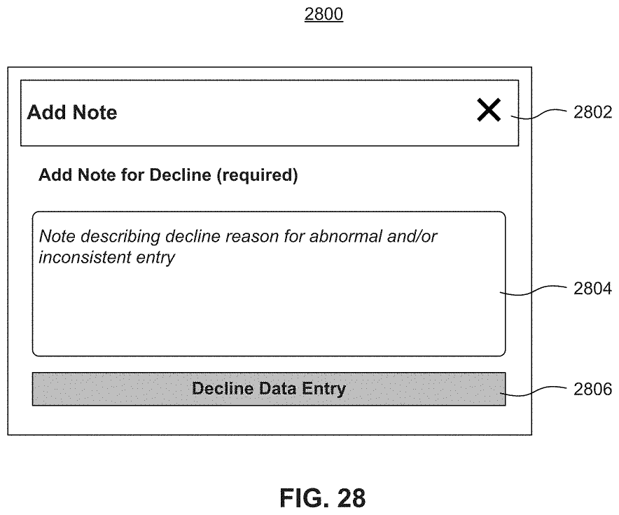

If integration system 105 determines that the role associated with the client ID is an administrator (step 2310: Yes), integration system 105 continues to step 2316. In step 2316, integration system 105 may generate a loader GUI displaying indicators of the users associated with real estate property (see FIG. 27). For example, integration system 105 may generate a loader GUI for display in an administrator device, the loader GUI displaying indicators of the users associated with a real estate property and a monthly sales reports, the monthly sales reports indicating whether respective ones of the users have transmitted new information, the loader GUI highlighting the indicators associated with abnormal monthly sales reports. In step 2318, integration system 105 may generate an approval GUI (FIG. 28) when receiving a selection of one of the indicators comprising a plurality of buttons and a chat box.

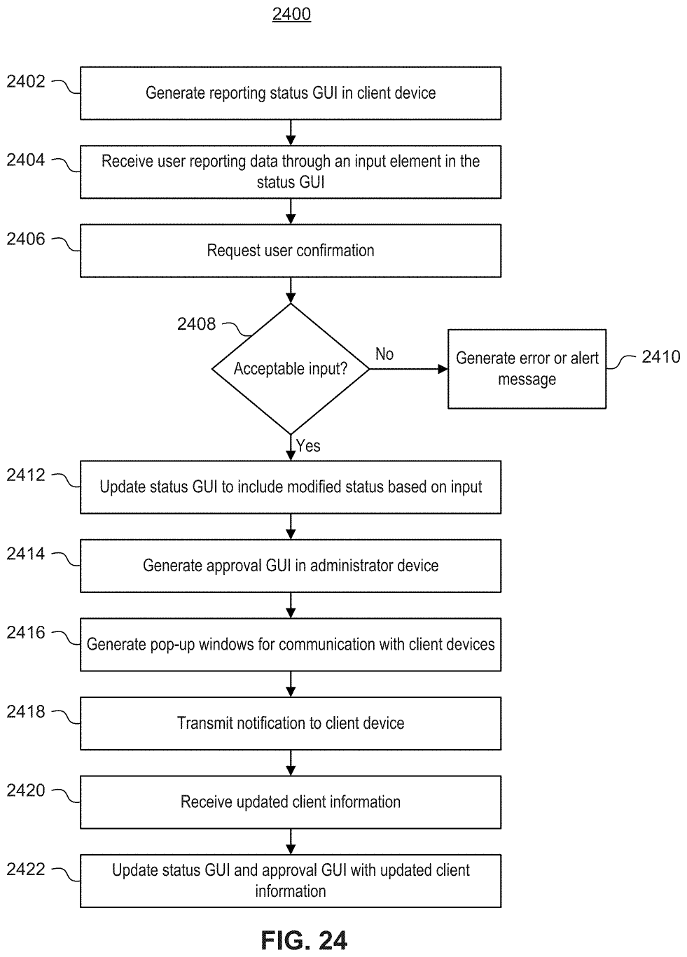

FIG. 24 is a flow chart illustrating an exemplary process 2400 for collection of user data, in accordance with disclosed embodiments. In some embodiments, process 2400 may be executed by integration system 105. For example, DNAA 110 may perform steps in process 2400. In other embodiments, however, process 2400 may be performed by client devices 150. Further, in some embodiments process 2400 may be performed by multiple elements of system 100. The description of process 2400 below illustrates an embodiment in which integration system 105 performs steps of process 2400, but other embodiments are possible.

In step 2402, integration system 105 may generate reporting status GUI in one of client devices 150. For example, after a user logs into a tenant account, integration system 105 may display a graphical user interface similar to the one shown in FIG. 25, displaying periodic reporting records and highlighting missing records. In step 2404, integration system 105 may receive user reporting data through an input element in the status GUI. For example, a user may select buttons in a GUI to transmit reporting information. Such selection may prompt integration system 105 to generate graphical user interfaces with input elements in which the user may input reporting data, such as sales information. An exemplary GUI showing the input icon is shown in FIG. 26A.

In step 2406, integration system 105 may request a user confirmation and or present a challenge. To avoid improper or inaccurate reporting, integration system 105 may determine whether inputs of step 2404 are abnormal or likely inaccurate. For example, integration system 105 may assess whether the inputted user data deviates from previous reporting trends. In such embodiments, integration system 105 may perform statistical analysis of inputted data and flag as abnormal data that is out of the mean and/or a selected standard deviation. Further, in step 2406 integration system 105 may challenge the user to confirm the input, as shown in FIG. 26B.

In step 2408, integration system 105 may determine whether the user input is acceptable. If integration system 105 determines that the user input is not acceptable (step 2408: No), integration system 105 may continue to step 2410 and generate error or alert message. But if integration system 105 determines that the user input is acceptable (step 2408: Yes), integration system 105 may continue to step 2412. In step 2412, integration system 105 may update a status GUI to include modified status based on input. For example, integration system 105 may update the indicator of reporting items in a GUI to reflect a user has already included the reporting information. In some embodiments, in step 2412 integration system 105 may remove warnings of missing information and or change labels in a status column, described in connection with FIG. 25.

In step 2414, integration system 105 may generate an approval GUI in administrator device. For example, integration system 105 may generate a GUI that shows buttons or hyperlinks associated with a plurality of users with reporting duties. In some embodiments, integration system 105 may show a graphical user interface similar to the one described in connection with FIG. 27. This user interface and/or website may allow administrators to review the reporting status of multiple users. As shown in FIG. 27, the approval GUI of step 2414 may allow an administrator to approve, decline, or review historic reporting for each one of the users. In step 2416, integration system 105 may generate pop-up windows for communication with client devices. For example, when an administrator selects a specific user in step 2414, integration system 105 may generate a pop-up window to create a not of one of the users.

In step 2418, integration system 105 may transmit an electronic notification to one or more client devices. Similarly as discussed in connection with FIG. 22, integration system may generate electronic notifications and/or contact services to send messages.

In step 2420, integration system 105 may receive updated client information. For example, integration system 105 may receive updated client or user information captured through GUI 2600 (FIG. 26A). Alternatively, or additionally, integration system 105 may receive updated client information through a webpage specified by a personalized URL as discussed in connection with FIG. 22. In step 2422, integration system 105 may update status GUI and approval GUI with updated client information. For example, once an administrator approves information updates from a client (e.g., through a user interface like the one shown in FIG. 27), integration system 105 may update records and modify status GUIs to show that the user provided reporting information.

Process 2400 may complement and/or support process 2200 to efficiently collect information from users. For example, the disclosed systems and methods improve the technical field of data collection by employing a series of GUI's with built in error detection, the ability to directly communicate with users, and personalized and simplified websites that allow users to easily enter information in a standardized format.

FIG. 25 shows an exemplary GUI 2500 displaying a periodic record, in accordance with disclosed embodiments. In some embodiments, integration system 105 may generate instructions to display GUI 2500 in client devices 150.

GUI 2500 may include a period ribbon 2502 with a plurality of buttons associated with hyperlinks. GUI 2500 may also include a reporting period column 2504 and an amount column 2506. Further GUI 2500 also includes a status column 2508 and an edit column 2510. Buttons in edit column 2510 may be programmed to generate windows, like the ones described in connection with FIG. 26, that capture user inputs. GUI 2500 may be generated in client devices 150 at, for example, step 2412 (FIG. 24).

FIG. 26A shows an exemplary GUI 2600 displaying an input window, in accordance with disclosed embodiments. In some embodiments, integration system 105 may generate instructions to display GUI 2600 in client devices 150. For example, integration system 105 may generate GUI 2600 when a user interacts with buttons in edit column 2510. GUI 2600 may include an input element 2602 and a button 2604. GUI 2600 may get generated in administrator devices, for example, at step 2314 (FIG. 23).

FIG. 26B shows an exemplary GUI 2650 displaying a confirmation window, in accordance with disclosed embodiments. In some embodiments, integration system 105 may generate instructions to display GUI 2650 in client devices 150. For example, integration system 105 may generate GUI 2650 when a user inputs data on input element 2602. GUI 2650 may include a pop-up window 2652, a cancel button 2654, and a confirmation button 2656.

FIG. 27 shows an exemplary loader GUI 2700 displaying for administrator users, in accordance with disclosed embodiments. In some embodiments, integration system 105 may generate instructions to display GUI 2700 in client devices 150. For example, integration system 105 may generate GUI 2700 when an administrator is authenticated, as discussed in connection with FIG. 23. GUI 2700 may include indicators 2702 representing a plurality of users and/or real property. GUI 2700 may also include a user window 2704, a status icon 2708, a decline button 2706, a mint button 2710, and an approve button 2712. In some embodiments, integration system 105 may generate GUI 2700 in administrator devices in step 2414 (FIG. 24).

FIG. 28 shows an exemplary approval GUI 2800, in accordance with disclosed embodiments. In some embodiments, integration system 105 may generate instructions to display GUI 2800 in client devices 150. For example, integration system 105 may generate GUI 2800 when a user interacts with decline button 2706. GUI 2800 may include a pop-up window 2802, an input element 2804, and a button 2806. In some embodiments, integration system 105 may generate GUI 2800 in administrator devices when an administrator selects decline button 2706 (FIG. 27).

FIG. 29 shows an exemplary GUI 2900 with an electronic notification for users, in accordance with disclosed embodiments. In some embodiments, integration system 105 may generate instructions to display GUI 2900 in client devices 150. For example, integration system 105 may generate GUI 2900 when transmitting electronic notifications as discussed in connection with FIG. 22. GUI 2900 may include a personalized message 2902 and a personalized link 2904 encoding a personalized URI.

Another aspect of the disclosure is directed to a non -transitory computer-readable medium storing instructions that, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage unit or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods. It is intended that the specification and examples be considered as exemplary only, with a true scope being indicated by the following claims and their equivalents.

Moreover, while illustrative embodiments have been described herein, the scope thereof includes any and embodiments having equivalent elements, modifications, omissions, combinations (e.g., of aspects across various embodiments), adaptations and/or alterations as would be appreciated by those in the art based on the present disclosure. For example, the number and orientation of components shown in the exemplary systems may be modified. Further, with respect to the exemplary methods illustrated in the attached drawings, the order and sequence of steps may be modified, and steps may be added or deleted. Furthermore, while some of the exemplary embodiments of the computerized methods were described using Java language or C to illustrate exemplary scripts and routines, the disclosed methods and systems may be implemented using alternative languages. The disclosed embodiments may use one or multiple programming languages in addition to Java or C. For example, the disclosed embodiments may also be implemented using Python, C++, C#, R, Go, Swift, Ruby, and/or their combinations.

Thus, the foregoing description has been presented for purposes of illustration only. It is not exhaustive and is not limiting to the precise forms or embodiments disclosed. Modifications and adaptations will be apparent to those skilled in the art from consideration of the specification and practice of the disclosed embodiments.

What is claimed is:

1. A system for generating personalized uniform resource locators (URLs) for data collection, the system comprising:
at least one processor; and
at least one memory device storing instructions that, when executed by the at least one processor, configure the at least one processor to perform operations comprising:
configuring an application programming interface (API) to communicate with a repository server storing information from real estate properties;
retrieving, using the API, records of real estate properties associated with a plurality of users;
identifying a subset of the plurality of users with upcoming reporting duties, based on the records;
generating personalized URLs encoding client identifiers (IDs) and account IDs for users in the subset;
transmitting the personalized URLs to client devices;
receiving, from one of the client devices, a website request through one of the personalized URLs;
in response to receiving the website request, determining a client ID and an account ID embedded in the one of the personalized URL through which the website request was received; and
generating a data collection website comprising a collection graphical user interface (GUI) displaying the client ID, a reporting period, and an input element.

2. The system of claim 1, wherein the operations further comprise:
receiving, from the one of the client devices via the collection GUI, user data associated with at least one of the real estate properties; and
updating the repository server with the user data through an API call.

3. The system of claim 1, wherein transmitting the personalized URLs comprises generating one or more electronic notifications including a hyperlink to at least one of the personalized URLs and transmitting the one or more electronic notifications to electronic addresses associated with the plurality of users.

4. The system of claim 1, wherein receiving the website request comprises:
receiving an authentication request;
identifying a role associated with the authentication request based on the client ID; and
in response to determining the role is tenant, generating a landing page comprising at least one of the personalized URLs.

5. The system of claim 4, wherein the repository server stores the information from the real estate properties through a data model comprising a plurality of objects configured with pre-programmed connections, the plurality of objects comprising an occupant object, an address object, a building object, and a bank object, wherein the building object stores a building ID.

6. The system of claim 1, wherein:
the collection GUI comprises an upload icon; and
the operations further comprise:
receiving a user file from the first client device;
associating the user file with one of the plurality of users;
identify a data model associated with the user file;
generate a searchable file based on the user file; and
updating the repository server with the searchable file through an API call.

7. The system of claim 6, wherein the operations further comprise:
after updating the repository server with the searchable file, transmitting a request to a vendor server, the request specifying a service request based on trends identified from the searchable file.

8. The system of claim 1, wherein transmitting the personalized URLs comprises transmitting at least one of push notifications or SMS with the personalized URL.

9. The system of claim 1, wherein identifying the subset of users comprises identifying users with a missing status associated with monthly sales reports.

10. The system of claim 9, the operations further comprise:
generating a loader GUI for display in an administrator device, the loader GUI displaying indicators of the plurality of users associated with the real estate properties and a monthly sales reports, the monthly sales reports indicating whether respective ones of the plurality of users have transmitted new information, the loader GUI highlighting the indicators associated with abnormal monthly sales reports; and
generating an approval GUI when receiving a selection of one of the indicators, the approval GUI comprising a plurality of buttons and a chat box.

11. A computer-implemented method for generating personalized uniform resource locators for data collection, the method comprising:
configuring an application programming interface (API) to communicate with a repository server storing information from real estate properties;
retrieving, using the API, records of real estate properties associated with a plurality of users;
identifying a subset of the plurality of users with upcoming reporting duties, based on the records;
generating personalized URLs encoding client identifiers (IDs) and account IDs for users in the subset;
transmitting the personalized URLs to client devices;
receiving, from one of the client devices, a website request through one of the personalized URLs;
in response to receiving the website request, determining a client ID and an account ID embedded in the one of the personalized URL through which the website request was received; and
generating a data collection website comprising a collection graphical user interface (GUI) displaying the client ID, a reporting period, and an input element.

12. The computer-implemented method claim 11, further comprising:
receiving, from the one of the client devices via the collection GUI, user data associated with at least one of the real estate properties; and
updating the repository server with the user data through an API call.

13. The computer-implemented method claim 11, wherein transmitting the personalized URLs comprises generating one or more electronic notifications including a hyperlink to at least one of the personalized URLs and transmitting the one or more electronic notifications to electronic addresses associated with the plurality of users.

14. The computer-implemented method claim 11,
wherein receiving the website request comprises:
receiving an authentication request;
identifying a role associated with the authentication request based on the client ID; and
in response to determining the role is tenant, generating a landing page comprising at least one of the personalized URLs.

15. The computer-implemented method claim 14,
wherein the repository server stores the information from the real estate properties through a data model comprising a plurality of objects configured with pre-programmed connections, the plurality of objects comprising an occupant object, an address object, a building object, and a bank object, wherein the building object stores a building ID.

16. The computer-implemented method claim 11, wherein:
the collection GUI comprises an upload icon; and
the operations further comprise:
receiving a user file from the first client device;
associating the user file with one of the plurality of users;
identify a data model associated with the user file;
generate a searchable file based on the user file; and
updating the repository server with the searchable file through an API call.

17. The computer-implemented method claim 16, further comprising:
after updating the repository server with the searchable file, transmitting a request to a vendor server, the request specifying a service request based on trends identified from the searchable file.

18. The computer-implemented method claim 11 wherein transmitting the personalized URLs comprises transmitting at least one of push notifications or SMS with the personalized URL.

19. The computer-implemented method claim 11, wherein:
identifying the subset of users comprises identifying users with a missing status associated with monthly sales reports; and
the method further comprises:
generating a loader GUI for display in an administrator device, the loader GUI displaying indicators of the plurality of users associated with the real estate properties and a monthly sales reports, the monthly sales reports indicating whether respective ones of the plurality of users have transmitted new information, the loader GUI highlighting the indicators associated with abnormal monthly sales reports; and
generating an approval GUI when receiving a selection of one of the indicators, the approval GUI comprising a plurality of buttons and a chat box.

20. A system comprising:
one or more processors;
one or more database storing information from real estate properties; and
at least one memory device storing instructions that, when executed by the at least one processor, configure the at least one processor to:
configure an application programming interface (API) to communicate with a repository server storing information from real estate properties;
retrieve, using the API, records of real estate properties associated with a plurality of users;
identify a subset of the plurality of users with upcoming reporting duties, based on the records;
generate personalized URLs encoding client identifiers (IDs) and account IDs for users in the subset;
transmit the personalized URLs to client devices;
receive, from one of the client devices, a website request through one of the personalized URLs;
in response to receiving the website request, determine a client ID and an account ID embedded in the one of the personalized URL through which the website request was received; and
generate a data collection website comprising a collection graphical user interface (GUI) displaying the client ID, a reporting period, and an input element.
